(19) United States
(12) Patent Application Publication
(10) Pub. No.: US 2011/0119156 A1
(43) Pub. Date: May 19, 2011

(54) SETTLEMENT RELAY METHOD AND SYSTEM FOR PERFORMING THE METHOD

(75) Inventors: Ji-Young HWANG, Seoul (KR); Oh-Seok KWON, Yongin-si (KR); Gyoung-Tae HA, Seoul (KR); Me-Ryoung JUNG, Seoul (KR)

(73) Assignee: iPayment

(21) Appl. No.: 12/946,929

(22) Filed: Nov. 16, 2010

(30) Foreign Application Priority Data
Nov. 16, 2009 (KR) 10-2009-0110062
Feb. 3, 2010 (KR) 10-2010-0010179

(51) Int. Cl. G06Q 30/00; G06K 5/00; G06Q 20/00

(52) U.S. Cl. 705/26.41; 235/380; 705/44

(57) ABSTRACT

A settlement relay system, which is connected to an affiliated shop terminal, a mobile communication terminal of a customer and a credit card company system, includes a communication part and a system control part. The communication part is connected to the affiliated shop terminal and the mobile communication terminal through a communication network. The system control part receives a settlement serial number data corresponding to a settlement from the mobile communication terminal via a communication network, receives a receipt serial number data from the affiliated shop terminal via a communication network, and performs a procedure corresponding to a transaction approval, when it is checked that the settlement serial number data and the receipt serial number data are matched with each other. Thus, a customer self settles through his/her own mobile communication terminal so that risk of duplication of the credit card may be prevented.

### CROSS-REFERENCE TO RELATED APPLICATIONS

This application claims the benefit of and priority under 35 U.S.C. §119 to Korean Patent Application No. 2009-110062, filed Nov. 16, 2009, and Korean Patent Application No. 2010-10179, filed Feb. 3, 2010, in the Korean Intellectual Property Office (KIPO), the contents of which are herein incorporated by reference in their entireties.

### BACKGROUND OF THE INVENTION

1. Field of the Invention

Example embodiments of the present invention relate to a settlement relay method and a system for performing the method. More particularly, example embodiments of the present invention relate to a settlement relay method, which provides a service that a user self settles a bill through a mobile communication terminal, and a system for performing the method.

2. Description of the Related Art

Generally, in a method which a price of goods is paid by using a credit card, when credit card information is inputted to a point of sale (“POS”) terminal installed at an affiliated shop to request an authentication by inputting a price of goods, the credit card information is transmitted to a credit card company through a communication network established by a value added network (“VAN”) company system. The credit card company determines whether or not the credit card is authorized, and then transmits a result of authentication to the affiliated shop through the communication network. When a usage of the credit card is authorized, a receipt is issued through the POS terminal and a signature is performed by a customer.

When the user has the credit card, the above method may be realized. However, when the user loses the credit card or does not have the credit card, making a payment with the credit card is impossible.

Moreover, a settlement signature of the user may be stored in a credit card settlement terminal, so that the credit card number and the settlement signature that are stored in the credit card settlement terminal may be always exposed to unauthorized people for illegal use.

In order to solve the problem, Korean Patent No. 10-0379918 discloses a mobile phone that is able to settle accounts on a credit card and its method of the settlement in which a credit card settlement function is added to a mobile phone to realize a credit card settlement through only a mobile phone.

That is, according to the Korean Patent No. 10-0379918, a credit card number and a password are pre-stored in a mobile communication company system. When a credit card selection button of the mobile phone is operated, the user may select one of credit cards and sequentially input a password of the credit card, an affiliated shop number and transaction details. Then, when a confirmation button is operated, the mobile phone is wirelessly connected to a credit card company system to realize an authentication request and an authentication result notification without going through the VAN company system.

However, according to the conventional art, since the user's own credit card information must be pre-stored in a mobile communication company server, personal information may be leaked out.

### SUMMARY OF THE INVENTION

Example embodiments of the present invention provide a settlement relay method, which provides a service that a user self settles a bill through a mobile communication terminal, at an infrastructure of a conventional credit card settlement.

Example embodiments of the present invention provide a settlement relay system for performing the above-mentioned method.

According to one aspect of the present invention, there is provided a settlement relay method by using a relay server connected to a terminal of an affiliated shop, a mobile communication terminal of a customer and a credit card company system. In the method, a settlement serial number data corresponding to a settlement is received from the mobile communication terminal via a communication network. Then, a receipt serial number data is received from the terminal of the affiliated shop via a communication network. Then, a procedure corresponding to a transaction approval is performed, when it is checked that the settlement serial number data and the receipt serial number data are matched with each other.

According to another aspect of the present invention, a settlement relay system, which is connected to a terminal of an affiliated shop, a mobile communication terminal of a customer and a credit card company system, includes a communication part and a system control part. The communication part is connected to the terminal of the affiliated shop and the mobile communication terminal through a communication network. The system control part (i) receives a settlement serial number data corresponding to a settlement from the mobile communication terminal via a communication network, (ii) receives a receipt serial number data from the terminal of the affiliated shop via a communication network, and (iii) performs a procedure corresponding to a transaction approval, when it is checked that the settlement serial number data and the receipt serial number data are matched with each other.

According to still another aspect of the present invention, there is provided a settlement relay method by using a relay server connected to a home shopping system, a mobile communication terminal of a customer and a credit card company system. In the method, a serial number of goods advertized at the home shopping system is received from the mobile communication terminal. Then, corresponding goods and customer information provided from the mobile communication terminal are transmitted to the home shopping system. Then, purchase detail information is transmitted to the mobile communication terminal, when goods information and delivery address information on a corresponding customer purchase are received from the home shopping system. Then, a settlement is requested to the credit card company system, when a credit card settlement through inputting a credit card number or a mobile secure socket layer (“SSL”) client certificate settlement through transmitting a mobile-SSL client certificate is request by the mobile communication terminal. Then, a settlement completion notification is transmitted to the mobile communication terminal and the home shopping system, when a settlement response to a corresponding settlement from the credit card system is provided.

According to further still another aspect of the present invention, a settlement relay system, which is connected to a home shopping system, a mobile communication terminal of a customer and a credit card company system, includes a communication part and a system control part. The communication part is connected to the home shopping system and the mobile communication terminal through a communication network. The system control part (i) receives a serial number of goods advertized at the home shopping system from the mobile communication terminal through the communication part, (ii) transmits corresponding goods and customer information provided from the mobile communication terminal to the home shopping system, (iii) transmits purchase detail information to the mobile communication terminal, when goods information and delivery address information on a corresponding customer purchase are received from the home shopping system, (iv) requests a settlement to the credit card company system, when a credit card settlement through inputting a credit card number or a mobile-SSL client certificate settlement through transmitting a mobile-SSL client certificate is request by the mobile communication terminal, and (v) transmits a settlement completion notification to the mobile communication terminal and the home shopping system, when a settlement response to a corresponding settlement from the credit card system is provided.

According to further still another aspect of the present invention, there is provided a settlement relay method by using a relay server connected to a terminal of an affiliated shop, a mobile communication terminal of a customer and a credit card company system. In the method, a number capable of identifying a credit card company, an affiliated shop number and the table number are received from the mobile communication terminal via a communication network. Then, a receipt serial number corresponding to the table number is requested to the affiliated shop terminal. Then, an affiliated shop number and the receipt serial number are received from the affiliated shop terminal. Then, an affiliated shop name corresponding to the affiliated shop number and a transaction amount are transmitted to the mobile communication terminal and a credit card settlement is requested to the mobile communication terminal. Then, the affiliated shop name and the receipt serial number are transmitted to the credit card company system. Then, an approval response corresponding to a settlement of the mobile communication terminal is received from the credit card company system. Then, the approval response is transmitted to the affiliated shop terminal and the mobile communication terminal.

According to further still another aspect of the present invention, a settlement relay system, which is connected to a terminal of an affiliated shop, a mobile communication terminal of a customer and a credit card company system, includes a communication part and a system control part. The communication part is connected to the affiliated shop terminal and the mobile communication terminal through a communication network. The system control part (i) receiving a number capable of identifying a credit card company, an affiliated shop number and the table number from the mobile communication terminal via the communication part, (ii) requesting a receipt serial number corresponding to the table number to the affiliated shop terminal via the communication part, (iii) receiving an affiliated shop number and the receipt serial number from the affiliated shop terminal via the communication part, (iv) transmitting an affiliated shop name corresponding to the affiliated shop number and a transaction amount via the communication part and requesting a credit card settlement to the mobile communication terminal via the communication part, (v) transmitting the affiliated shop name and the receipt serial number to the credit card company system via the communication part, (vi) receiving an approval response corresponding to a settlement of the mobile communication terminal from the credit card company system via the communication part, and (vii) transmitting the approval response to the affiliated shop terminal and the mobile communication terminal via the communication part.

According to a settlement relay method and a system for performing the method, a customer does not need to provide his/her credit card to an unauthorized person to make a payment at an infrastructure of a conventional credit card settlement, and the customer self settles through his/her own mobile communication terminal so that risk of duplication of the credit card may be prevented. Moreover, an illegal usage may be prevented, for example, a settlement signature which will be stored in a terminal of an affiliated shop may be illegally used in accordance with a credit card settlement.

### BRIEF DESCRIPTION OF THE DRAWINGS

The above and other features and advantages of the present invention will become more apparent by describing in detailed example embodiments thereof with reference to the accompanying drawings, in which:

FIG. 1 is a conceptual diagram illustrating a settlement relay system according to an exemplary embodiment of the present invention;

FIG. 2 is a block diagram illustrating a relay server described in FIG. 1;

FIGS. 3A, 3B and 3C are flowcharts showing a settlement relay scenario in accordance with a settlement relay system according to an exemplary embodiment of the present invention;

FIGS. 4A, 4B and 4C are flowcharts showing a settlement relay scenario in accordance with a settlement relay system according to another exemplary embodiment of the present invention;

FIGS. 5A, 5B, 5C, 5D and 5E are images showing examples of a display screen of a mobile communication terminal;

FIG. 6 is a flowchart showing a settlement relay method according to an exemplary embodiment of the present invention;

FIG. 7 is a conceptual diagram illustrating a settlement relay system according to another exemplary embodiment of the present invention;

FIG. 8 is a conceptual diagram illustrating a settlement relay system according to still another exemplary embodiment of the present invention;

FIG. 9 is a conceptual diagram illustrating a settlement relay system according to still another exemplary embodiment of the present invention;

FIGS. 10A, 10B and 10C are flowcharts showing a settlement relay scenario in accordance with a settlement relay system according to another exemplary embodiment of the present invention;

FIGS. 11A, 11B, 11C, 11D and 11E are images showing examples of a display screen of a mobile communication terminal;

FIG. 12 is a flowchart showing a settlement relay method according to another exemplary embodiment of the present invention;

FIG. 13 is a conceptual diagram illustrating a settlement relay system according to still another exemplary embodiment of the present invention;

FIGS. 14A, 14B, 14C and 14D are flowcharts showing a settlement relay scenario described in FIG. 13;

FIG. 15 is a conceptual diagram illustrating a settlement relay system according to still another exemplary embodiment of the present invention;

FIGS. 16A, 16B and 16C are images showing examples of a display screen of a point-of-sale (hereinafter, referred to as “POS”) terminal or a mobile communication terminal at a settlement relay system described in FIG. 15;

FIGS. 17A and 17B are flowcharts showing a settlement relay scenario described in FIG. 15;

FIG. 18 is a conceptual diagram illustrating a settlement relay system according to still another exemplary embodiment of the present invention;

FIGS. 19A and 19B are flowcharts showing a method of relaying a settlement described in FIG. 18;

FIG. 20 is a conceptual diagram illustrating a settlement relay system according to still another exemplary embodiment of the present invention;

FIGS. 21A, 21B, 21C, 21D, 21E and 21F are images showing examples of a display screen of a mobile communication terminal; and

FIGS. 22A, 22B and 22C are images showing examples of a display screen of a mobile communication terminal for explaining operations generating a mobile secure socket layer (hereinafter, referred to as “SSL”) client certificate explained in FIGS. 20 to 22F.

### DETAILED DESCRIPTION OF THE INVENTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

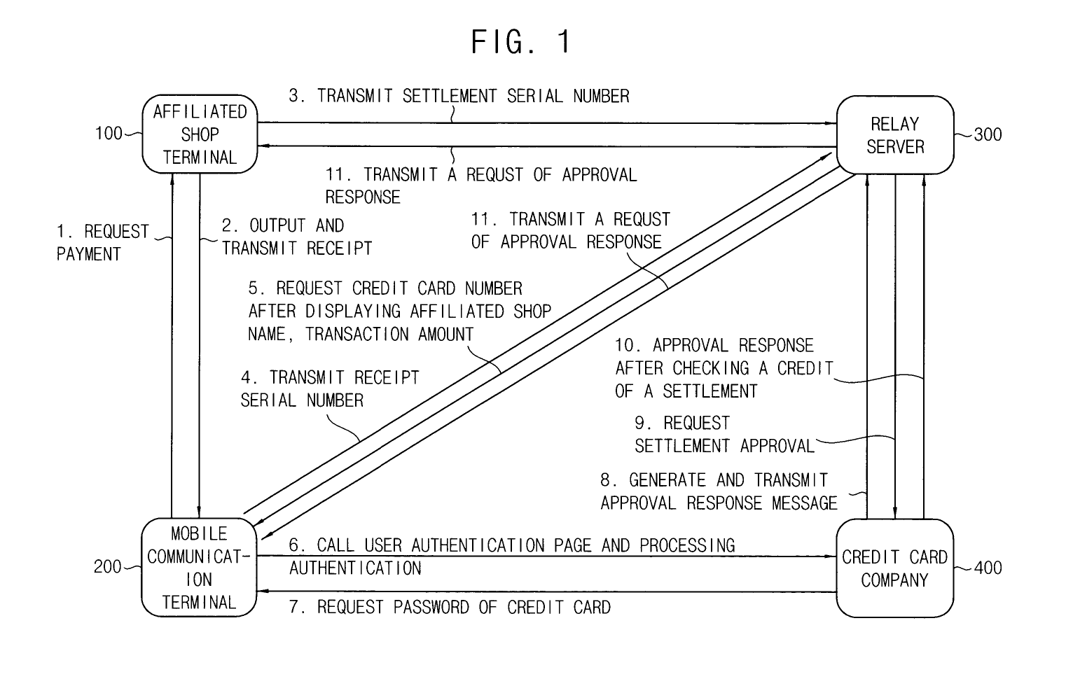

FIG. 1 is a conceptual diagram illustrating a settlement relay system according to an exemplary embodiment of the present invention.

Referring to FIG. 1, a settlement relay system according to an exemplary embodiment of the present invention may be explained by an affiliated shop terminal 100, a mobile communication terminal 200, a relay server 300 and a credit card company system 400.

When a settlement is requested from a customer possessing the mobile communication terminal 200, the affiliated shop terminal 100 may print or generate a receipt. The receipt may be delivered to a corresponding customer. The receipt may include an inherent number or a code of an affiliated shop, a transaction amount, etc. For one example, a bar code corresponding to the inherent number or the code of the affiliated shop, the transaction amount, etc., may be printed on the receipt. The bar code may be scanned by the mobile communication terminal 200. In order to scan the bar code, the mobile communication terminal 200 may have a bar code reader. For another example, a quick response (“QR”) code corresponding to the inherent number or the code of the affiliated shop, the transaction amount, etc., may be printed on the receipt. The QR code may be scanned or photographed by the mobile communication terminal 200. In order to scan or photograph the bar code, the mobile communication terminal 200 may have a QR code reader. Alternatively, when a settlement is requested from a customer possessing the mobile communication terminal 200, the affiliated shop terminal 100 may transmit a receipt to a mobile communication terminal 200 of a corresponding customer in an online manner. The affiliated shop terminal 100 and the mobile communication terminal 200 may be connected to each other through a near distance wireless communication network such as Wi-Fi Network, etc. In order to realize a wireless condition by the near distance wireless communication network, an access point may be further disposed in an area in which the affiliated shop terminal 100 or the mobile communication terminal 200 is positioned. The access point may perform a role of an interface between the affiliated shop terminal 100 and the mobile communication terminal 200.

In this exemplary embodiment, the affiliated shop terminal 100 may include a point-of-sale (hereinafter, referred to as “POS”) terminal, a credit card inquiring machine terminal, etc. The credit card inquiring machine terminal may be a card authorization terminal (hereinafter, referred to as “CAT”). When a simple software is installed to the affiliated shop terminal 100 or the affiliated shop terminal 100 is upgraded, the affiliated shop terminal 100 may be easily adapted to a settlement relay service according to the present invention. That is, the affiliated shop terminal 100 controls that a conventional POS terminal or a conventional CAT terminal requests an authentication without a credit card, and outputs a serial number, for example, an identification code of an affiliated shop and a transaction classification code which will be quoted to a customer in a receipt (or a bar code).

Moreover, the affiliated shop terminal 100 transmits a settlement serial number data (hereinafter, settlement serial number) corresponding to the printed receipt to the relay server 300. The settlement serial number may include an inherent number or a code of an affiliated shop, a transaction amount, etc. The affiliated shop terminal 100 may automatically check service details to transmit the checked service details to the relay server 300. Alternatively, when the affiliated shop terminal 100 does not automatically check corresponding service details, an affiliated shop manager may manually input details of a corresponding service.

When a customer receives the printed receipt, the mobile communication terminal 200 of the customer wirelessly transmits a receipt serial number data (hereinafter, a receipt serial number) printed on the receipt to the relay service system 300. For example, an affiliated shop code, a service code (or a table code), a phone number data, a requesting time, etc., are wirelessly transmitted to the relay service system 300. Alternatively, the mobile communication terminal 200 may receive the receipt serial number data from the affiliated shop terminal 100 through near distance wireless communication network. In this case, a position detecting by the affiliated shop 100 may be performed based on table information corresponding to the mobile communication terminal 200. In this exemplary embodiment, the mobile communication terminal 200 is a terminal in which a program for realizing a service according to the present invention is downloaded to be installed. For one example, the mobile communication terminal 200 may automatically identify a credit card for a settlement. For another example, a customer may input his/her credit card number or a mobile secure socket layer (hereinafter, referred to as “SSL”) client certificate to the mobile communication terminal 200. In this exemplary embodiment, the mobile communication terminal 200 may include a cellular phone, a portable phone, a person digital assistant (“PDA”), etc. In this exemplary embodiment, the mobile SSL client certificate may be generated by encoding an SSL client certificate and a credit card number through an encoding program provided from the relay server 300. The credit card number may include at least one. Additionally, the mobile SSL client certificate may include not only the credit card number encoded in an SSL client certificate but also a phone number data of the mobile communication terminal 200.

The relay server 300 may receive a serial number transmitted from the affiliated shop terminal 100. Moreover, the affiliated shop terminal 300 may receive a receipt serial number transmitted from the mobile communication terminal 200. The receipt serial number may include an inherent number or a code of an affiliated shop, a transaction amount, etc.

The relay server 300 checks whether or not a settlement serial number transmitted from the affiliated shop terminal 100 and a receipt serial number transmitted from the mobile communication terminal 200 are matched. When the settlement serial number and the receipt serial number are matched, the relay server 300 transmits an affiliated shop name and a transaction amount to the mobile communication terminal 200 to request that corresponding information is displayed on the mobile communication terminal 200. Moreover, the relay server 300 may further request a credit card number or a mobile SSL client certificate.

The mobile communication terminal 200 displays an affiliated shop name, a settlement amount, etc., provided from the relay server 300 onto a display window thereof.

When it is checked that no error is found in information displayed thereon, that is, information such as an affiliated shop name, a transaction amount, etc., a customer possessing a corresponding mobile communication terminal 200 may finish a settlement by inputting or selecting settlement information. In this case, the settlement information may be stored in a corresponding mobile communication. Here, a mobile communication terminal having settlement information stored therein may be a terminal employing a universal subscriber identity module (hereinafter, referred to as “USIM”) or a terminal having an electronic wallet function.

Alternatively, when it is checked that no error is found in information displayed thereon, that is, information such as an affiliated shop name, a transaction amount, etc., a customer may input information for user authentication to the mobile communication terminal 200. In a case of a small sum settlement, a user authentication process may be omitted in accordance with a financial company. In this exemplary embodiment, the user authentication method may utilize a security system which is admitted to a customer and a bank company system. For example, the user authentication method may utilize a method which is obeyed in a security policy of a nation (i.e., a security policy of the financial supervisory service).

For one example, user authentication information is encoded through one time key data known to only a customer and a financial company, and then the encoded user authentication information is delivered to the customer and the financial company through a relay server. For another example, a user inputs user authentication information onto a mobile screen, which is provided from a financial company, directly connected to a financial company, the financial company delivers a result of the user authentication information to the relay server through the mobile communication terminal, and then the relay server delivers the result of the user authentication information to the financial company.

In this exemplary embodiment, an example performing an authentication through a financial company will be described. That is, the customer enters a credit card number or a mobile SSL client certificate for obtaining an authentication through his/her own mobile communication terminal. An entry of the credit card number may be performed in a same display window displaying the affiliated shop name and a transaction amount. Alternatively, as a confirmation button notifying no error found in the affiliated shop name and the transaction amount is clicked, the entry of the credit card number may be performed by additionally displaying a display window inquiring an input of the credit card number or a mobile SSL client certificate. In the present exemplary embodiment, a credit card user authentication may be realized by inputting numerals or a combination of numerals and alphabet letters. In addition, the credit card user authentication may be directly authorized at the credit card company so as to obey a security rule of the financial supervisory service.

When a customer receives a credit card number entry request from the relay server 300, the customer calls a user authentication page to request an authentication process to the credit card company system 400.

The credit card company system 400, which receives a request for calling a user authentication page and an authentication process from the mobile communication terminal 200, requires an inputting of a password for a corresponding credit card to the customer.

When a password of a credit card is transmitted from the mobile communication terminal 200, the credit card company system 400 processes an authentication of the password. When it is checked that the mobile communication terminal 200 has an authentication, the credit card company system 400 generates an authentication response full message data to transmit the authentication response full message data to the relay server 300.

When the relay server 300 receives an authentication response full message data, the relay server 300 requests a settlement authentication to the credit card company system 400.

When the credit card company system 400 receives a settlement authentication request, the credit card company system 400 checks a settlement loan for a corresponding credit card. When it is checked that the corresponding credit card has a settlement loan, the credit card company system 400 transmits an approval response signal to the relay server 300.

When the relay server 300 receives the approval response signal, the relay server 300 transmits an approval response result to the affiliated shop terminal 100 and the mobile communication terminal 200.

Accordingly, the affiliated shop terminal 100 may confirm that a settlement for a corresponding transaction is finished, and the mobile communication terminal 200 may confirm that a settlement for the corresponding transaction is finished.

Hereinafter, a scenario in which a settlement relay system according to an exemplary embodiment of the present invention described above is adapted to a restaurant will be briefly described.

A clerk of an affiliated shop operates a POS system to generate or print a receipt of a corresponding table. For one example, when the receipt is printed, the clerk delivers the printed receipt to a customer and then explains a service that is realized in accordance with the present invention. When the customer has a knowledge of the service, the explaining about the service may be omitted or simplified. For another example, when the receipt is generated, the clerk operates the POS system to transmit the receipt to the customer's mobile communication terminal.

Then, the customer drives a settlement program installed at his/her own mobile communication terminal to select a settlement menu. Then, the customer inputs a receipt serial number printed on the receipt and then clicks on a confirmation button displayed or disposed on his/her mobile communication terminal.

Then, a relay server checks whether or not a receipt serial number provided from an affiliated shop POS system and a settlement serial number data provided from a customer's mobile communication terminal are matched with each other, and receives an authentication of a terminal status for a corresponding mobile communication terminal from a mobile communication company. When the authentication of the terminal status is abnormal, the clerk explains an error status to the customer to finish a settlement. When the authentication of a terminal status is normal, the clerk shows a corresponding transaction to the customer to request an inputting of a credit card number, a monthly installment plan period, etc.

Then, the relay server confirms a credit card number for a settlement request, and then requests a user authentication for a credit card to a corresponding credit card company system. Then, the credit card company system requests an inputting of a password of a credit card number through a customer's mobile communication terminal in order to perform a credit card user authentication, and authenticates the password to deliver the result of the authentication to the relay server. Then, the relay server confirms an authentication result, and requests an authentication to a credit card company system. The relay server delivers a message that an authentication is preceding to the customer's mobile communication.

Then, when an authentication response is received from the credit card company system, the relay server sends corresponding authentication details to a POS system of an affiliated shop and sends a transaction result message to a customer's mobile communication terminal. Then, the clerk delivers a settlement receipt to the customer.

As described above, according to an exemplary embodiment of the present invention, a customer downloads a program for realizing a service according to the present invention through his/her own mobile communication terminal to install the program into the mobile communication terminal, and the customer performs a settlement through the installed program. Thus, the customer does not allow unauthorized people to access his/her own credit card so as for a settlement, so that risk of loss or risk of duplication of a corresponding credit card may be prevented.

Moreover, when a settlement is performed on a credit card, a settlement signature may continuously remain in a credit card terminal. However, according to the present invention, an illegal usage may be prevented, for example, duplication of the credit card and illegal usages of a settlement signature as well as a credit card number.

Generally, when a credit card or a debit/check card is used, a signature of a customer is required so that an additional receipt for obtaining a signature of the customer is required. The receipt may be formed in a piece of paper. However, according to the present invention, an additional receipt for obtaining a signature of a customer is not required, so that a usage of paper may be restrained. Moreover, a usage of an ink for printing the receipt may be restrained.

Moreover, in an aspect of a financial company, a work for issuing a credit card may be omitted, so that expenses for issuing a credit card and human labor for delivering the credit card to a user may be reduced.

Moreover, according to the present invention, settlements of a credit card, a debit/check card, a cash, etc., are possible, so that it may be easy to count the total sales of each shop. Consequently, the national tax service may impose a duty based on the total sales, so that an omission of the tax may be prevented.

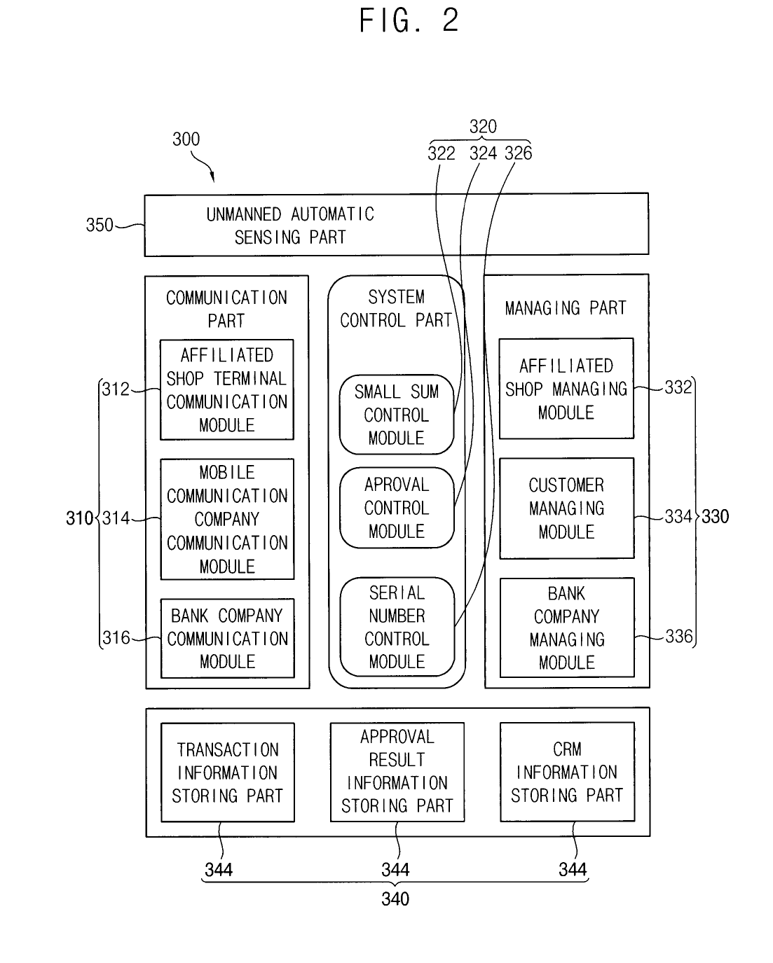

FIG. 2 is a block diagram illustrating a relay server 300 described in FIG. 1.

Referring to FIG. 2, the relay server 300 according to the present invention includes a communication part 310, a system control part 320, a managing part 330 and a storing part 340. In the present exemplary embodiment, the communication part 310, the system control part 320, the managing part 330 and the storing part 340 are described in logical terms for ease of understanding, whether or not they are separate physical hardware elements.

The communication part 310 includes an affiliated shop terminal communication module 312, a mobile communication module 314 and a bank company communication module 316. In the present exemplary embodiment, the affiliated shop terminal communication module 312, the mobile communication module 314 and the bank company communication module 316 are described in logical terms for ease of understanding, whether or not they are separate physical hardware elements.

The affiliated shop terminal communication module 312 is connected to a plurality of affiliated shop terminals through communication networks to receive signals provided from each affiliated shop terminal, and transmits signals provided from a relay server 300 to a corresponding affiliated shop terminal.

The mobile communication module 314 is connected to the mobile communication company system through a communication network to play a role of a passage through which a signal outputted from the relay server 300 is transmitted to a mobile communication company system or play a role of a passage through which a signal outputted from a mobile communication company system is transmitted to a relay server 300.

The bank company communication module 316 is connected to the bank company system through a communication network to play a role of a passage through which a signal outputted from the relay server 300 is transmitted to the bank company system or play a role of a passage through which a signal outputted from the bank company system is transmitted to the relay server 300.

The system control part 320 includes a small sum settlement control module 322, an authentication control module 324 and a serial number control module 326. In the present exemplary embodiment, the small sum settlement control module 322, the authentication control module 324 and the serial number control module 326 are described in logical terms for ease of understanding, whether or not they are separate physical hardware elements.

As a settlement corresponding to a small sum settlement is requested from a customer's mobile communication terminal through the mobile communication module 314, the small sum settlement control module 322 checks whether or not a corresponding amount corresponds to a small sum settlement. When it is checked that the corresponding amount corresponds to the small sum settlement, the small sum settlement control module 322 processes a settlement to send the fact to a corresponding mobile communication terminal and a corresponding affiliated shop terminal.

The approval control module 324 requests a confirmation whether or not a corresponding mobile communication terminal is lost to a mobile communication company system corresponding to the corresponding mobile communication terminal, and then performs an operation in accordance with a response provided from the corresponding mobile communication terminal. For example, when it is checked that the corresponding mobile communication terminal is lost, the approval control module 324 notifies a corresponding fact to a corresponding affiliated shop terminal. In addition, the approval control module 324 may further notice that the corresponding mobile communication terminal is lost to a corresponding mobile communication terminal.

The serial number control module 326 controls a storing of a receipt serial number provided from an affiliated shop terminal, and controls a storing of a settlement serial number provided from a mobile communication terminal. Moreover, the serial number control module 326 checks whether or not the receipt serial number and the settlement serial number are matched with each other.

The managing part 330 includes an affiliated shop managing module 332, a customer managing module 334 and a bank company managing module 336. In the present exemplary embodiment, the affiliated shop managing module 332, the customer managing module 334 and the bank company managing module 336 are described in logical terms for ease of understanding, whether or not they are separate physical hardware elements.

The affiliated shop managing module 332 manages affiliated shop terminals corresponding to affiliated shops.

The customer managing module 334 manages mobile communication terminal information of a customer, customer information, etc.

The bank company managing module 336 manages bank company information of a customer, bank company information of an affiliated shop, etc.

The storing part 340 includes a transaction information storing part 342, authentication result information storing part 344 and a customer relationship management (“CRM”) information storing part 346. In the present exemplary embodiment, the transaction information storing part 342, the authentication result information storing part 344 and the CRM information storing part 346 are described in logical terms for ease of understanding, whether or not they are separate physical hardware elements.

Transaction information is stored in the transaction information storing part 342.

Authentication result information is stored in the authentication result information storing part 344.

CRM information is stored in the CRM information storing part 346. In this exemplary embodiment, the stored CRM information may be adapted to a retail shop sales, a field sales, a communication sales, a web sales, etc. Moreover, the stored CRM information may be adapted to a campaign, a content developing, etc. Furthermore, the stored CRM information may be adapted to a service such as a call center, a web service, a wireless service, etc. Furthermore, the stored CRM information may be adapted to a new product developing, a business developing, etc.

The relay server 300 may further include an unmanned automatic sensing part 350. The unmanned automatic sensing part 350 may perform a monitoring operation, an automatically backup operation, etc.

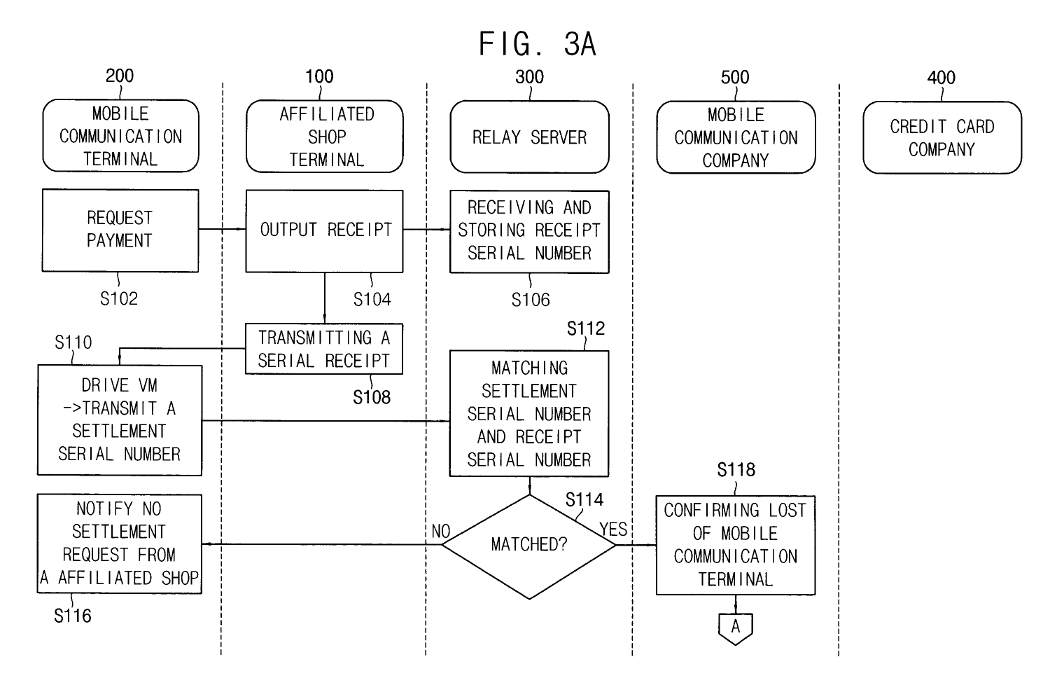

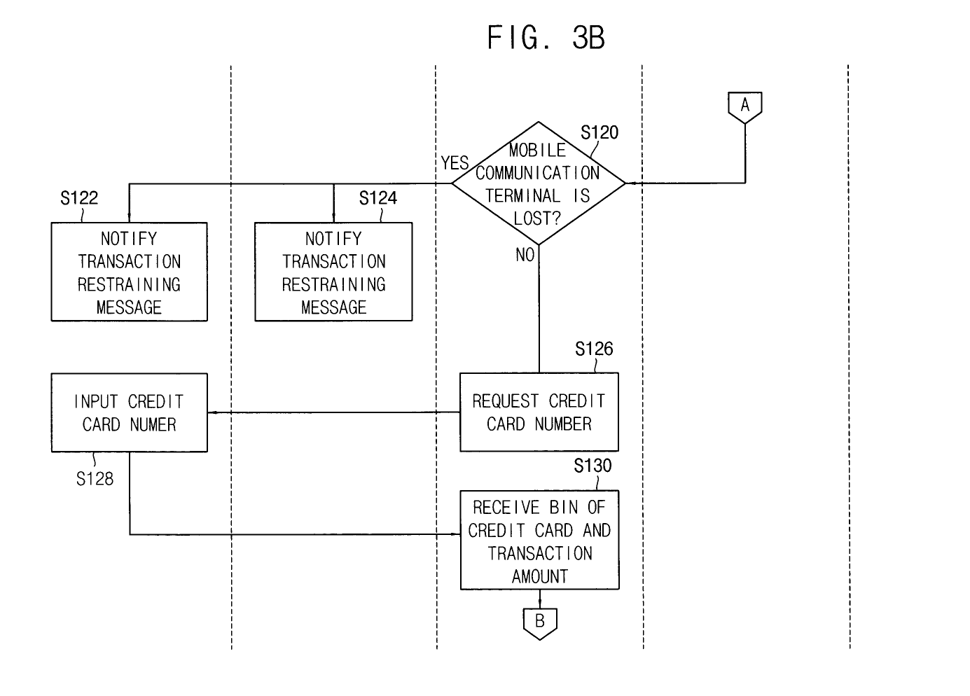

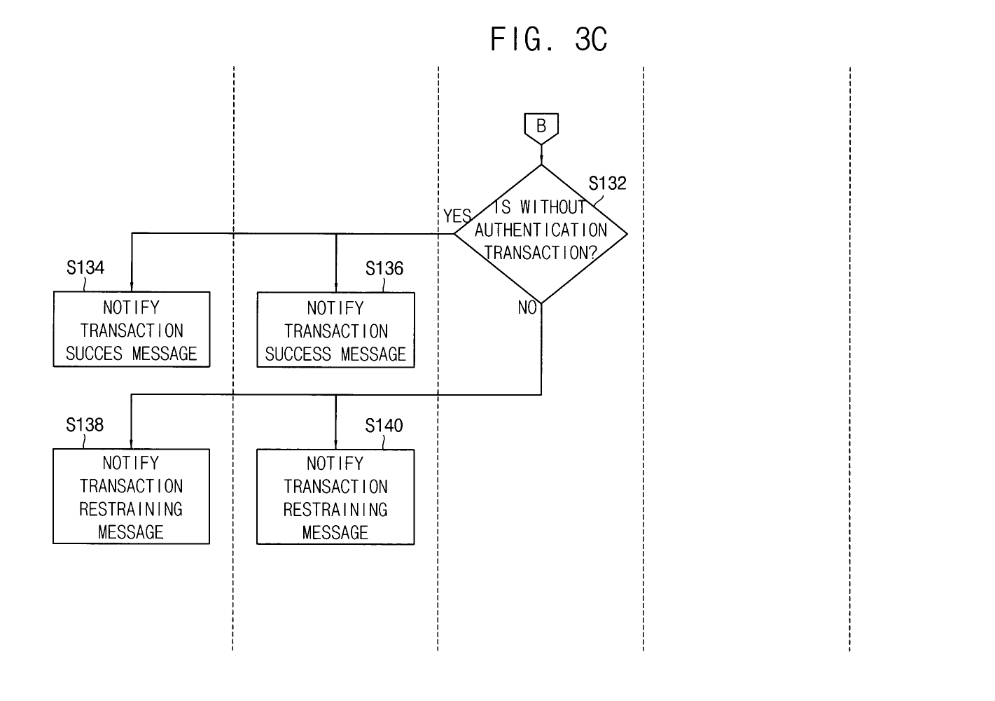

FIGS. 3A, 3B and 3C are flowcharts showing a settlement relay scenario in accordance with a settlement relay system according to an exemplary embodiment of the present invention.

Referring to FIGS. 1, 3A, 3B and 3C, a customer possessing the mobile communication terminal 200 requests a settlement to a manager of an affiliated shop in which an affiliated shop terminal 100 is disposed (step S102).

Thus, a corresponding affiliated shop terminal 100 may print or generate a receipt, and then transmits a receipt serial number corresponding to the receipt that is printed or generated to the relay server 300 (step S104). The relay server 300 receives the receipt serial number of an affiliated shop, and then stores the received receipt serial number (step S106). The receipt serial number may include an affiliated shop name, a transaction amount, etc. Moreover, the affiliated shop terminal 100 may transmit the receipt to the mobile communication terminal 200 possessed by a customer (step S108). Alternatively, a manager of the affiliated shop may deliver the printed receipt to a customer possessing the mobile communication terminal 200.

The mobile communication terminal 200 drives a virtual machine (“VM”) program or an application program for a smart phone to transmit a settlement serial number to the relay server 300 by using the driven VM program or the application program for a smart phone (step S110). In this case, personal information is not included in the settlement serial number which is transmitted from the mobile communication terminal 200 to the relay server 300. For example, the settlement serial number includes an inherent number of an affiliated shop, a number corresponding to goods data, transaction amount information, etc.

When a settlement serial number of the mobile communication terminal 200 is received, the relay server 300 matches the received settlement serial number and the receipt serial number of an affiliated shop (step S112).

It is checked whether or not the received settlement serial number and the receipt serial number of an affiliated shop are matched (step S114). When the received settlement serial number and the receipt serial number of an affiliated shop are not matched with each other, the relay server 300 notifies that corresponding transaction settlement is not requested from an affiliated shop (step S116). Moreover, when the received settlement serial number and the receipt serial number of an affiliated shop are matched with each other, the relay server 300 requests to check whether or not a corresponding mobile communication terminal 200 is lost to a mobile communication company system 500.

As a signal requesting to check whether or not a corresponding mobile communication terminal 200 is lost received from the relay server 300, the mobile communication company system 500 inquires to check whether or not the corresponding mobile communication terminal 200 is lost, and then transmits the inquired result to the relay server 300 (step S118).

As a lost result data is received from the mobile communication company 500, the relay server 300 checks whether or not a corresponding mobile communication terminal 200 is the lost terminal (step S120). As a result, when it is checked that the corresponding mobile communication terminal is lost, the relay server 300 sends a transaction restraining message to a corresponding mobile communication terminal 200 (step S122). Moreover, the relay server 300 sends a transaction restraining message to the affiliated shop terminal 100 (step S122).

When it is checked that the corresponding mobile communication terminal is not lost, the relay server 300 transmits a signal, which requests information including an affiliated shop name and a transaction amount and a credit card number or a mobile SSL client certificate for a corresponding transaction, to the mobile communication terminal 200 (step S126).

As the affiliated shop name and a transaction amount are displayed on a mobile communication 200, a customer checks the affiliated shop name and the transaction amount. Moreover, as the customer enters a credit card number corresponding to a transaction into a corresponding blank requesting a credit card number, the mobile communication terminal 200 transmits the credit card number to the relay server 300 (step S128). In addition, the mobile communication terminal 200 transmits a mobile SSL client certificate to the relay server 300.

The relay server 300 receives a bank identification number (“BIN”) of a credit card and a transaction amount (step S130).

The relay server 300 checks whether or not a corresponding transaction is a No Authentication Required transaction based on a BIN of a credit card and an amount (step S132). In this case, the No Authentication Required transaction may be a small sum settlement, a USIM settlement, an electron signature settlement, a password settlement, etc. The small sum settlement represents a settlement which is performed by inputting a BIN of a credit card without an additional signature or an authentication. The USIM settlement represents a settlement which is performed by using a USIM credit card inserted to a mobile communication terminal even though the mobile communication terminal is user's. The electron signature settlement represents a settlement in which an electric signature is stored in a mobile communication terminal to settle by using the stored electric signature. The password settlement represents a settlement in which a password is inputted by a user to settle a bill.

In the step S132, when it is checked that a corresponding transaction is a No Authentication Required transaction, the relay server 300 transmits a transaction success message according to the No Authentication Required transaction to the mobile communication terminal 200 (step S134). Moreover, the relay server 300 transmits the transaction success message according to the No Authentication Required transaction to the affiliated shop terminal 100 (step S136).

When it is checked that a corresponding transaction is not the No Authentication Required transaction, the relay server 300 transmits a transaction restraining message according to the No Authentication Required transaction, that is, a transaction restraining message that a corresponding transaction is required an authentication, to the mobile communication terminal 200 (step S138). In this exemplary embodiment, the transaction restraining message may be a message inducing an authentication. Moreover, the relay server 300 transmits a transaction restraining message according to the No Authentication Required transaction, that is, a message that a corresponding transaction requires an authentication, to the affiliated shop terminal 100 (step S140). The mobile communication terminal receives a message requiring an authentication of a corresponding transaction to display a corresponding message. A user may perform an authentication process so as to finish a corresponding settlement. The authentication process may be realized by directly inputting user authentication information. In this exemplary embodiment, the user authentication method may utilize a security system which is admitted to a customer and a bank company system. For example, the user authentication method may utilize a method which is obeyed in a security policy of a nation (i.e., a security policy of the financial supervisory service).

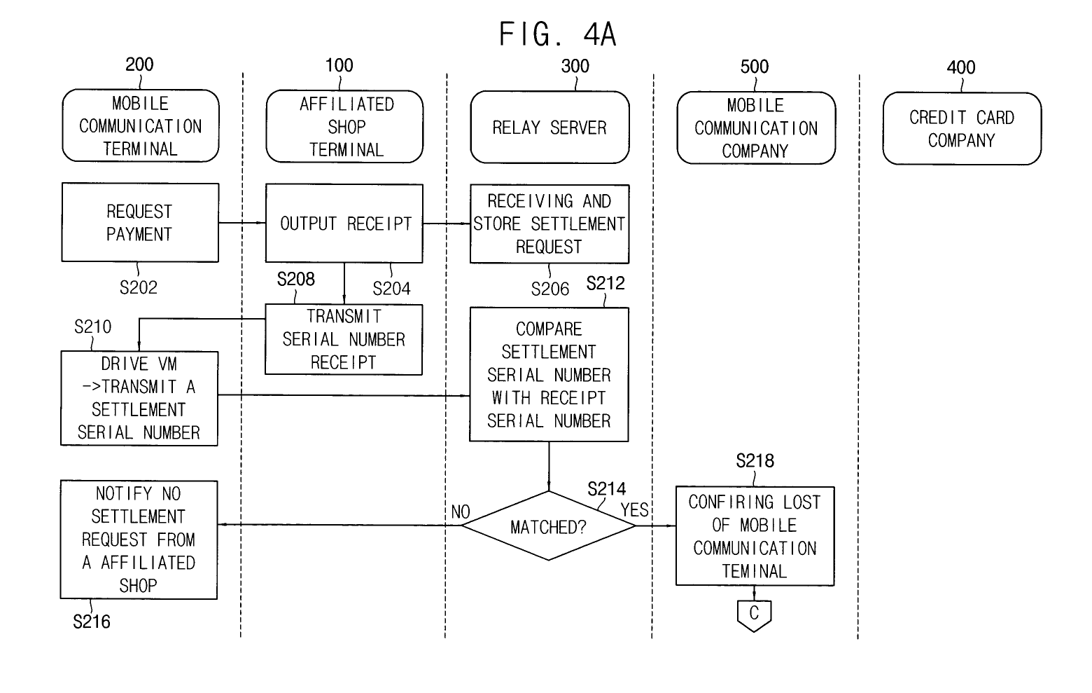

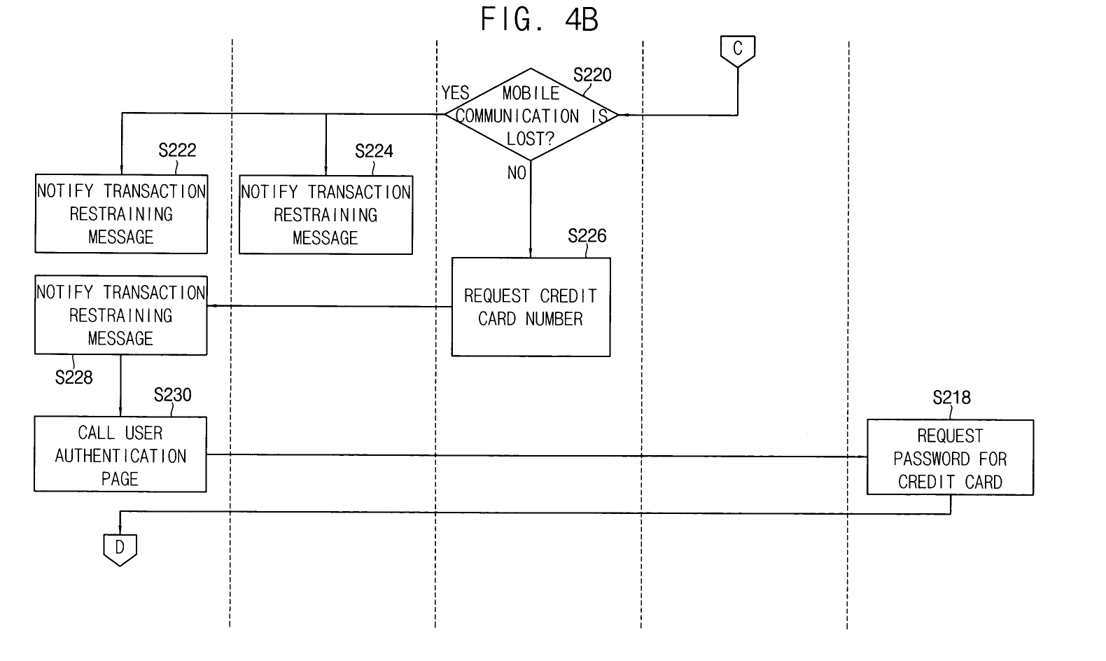

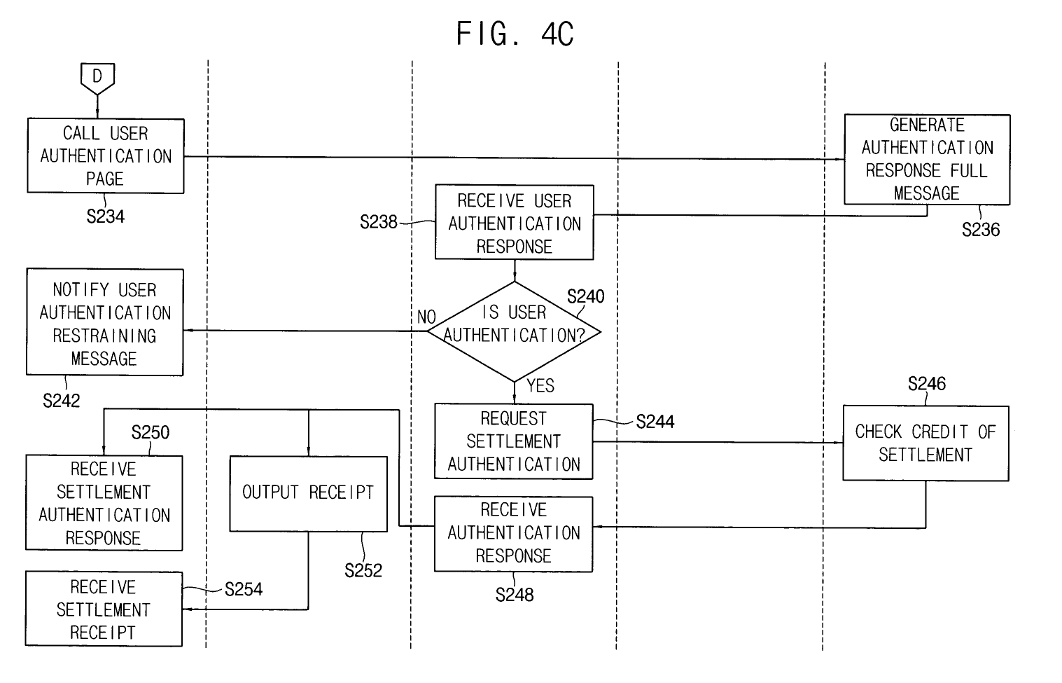

For one example, user authentication information is encoded through one time key data known to only a customer and a financial company, and then the encoded user authentication information is delivered to the customer and the financial company through a relay server. For another example, a user inputs user authentication information onto a mobile screen, which is provided from a financial company, directly connected to a financial company, the financial company delivers a result of the user authentication information to the relay server through the mobile communication terminal, and then the relay server delivers the result of the user authentication information to the financial company. The approval process will be explained in detail with reference to FIGS. 4A and 4B, so that any repetitive detailed description thereof will hereinafter be omitted or simplified.

As described above, a customer does not need to perform a settlement by providing unauthorized people with his/her own credit card at an infrastructure of a conventional credit card settlement, and the user oneself performs a settlement through his/her own mobile communication terminal so that risk of duplication of the credit card may be prevented. Moreover, an illegal usage may be prevented, for example, illegally using a settlement signature stored in an affiliated shop terminal in accordance with a credit card settlement.

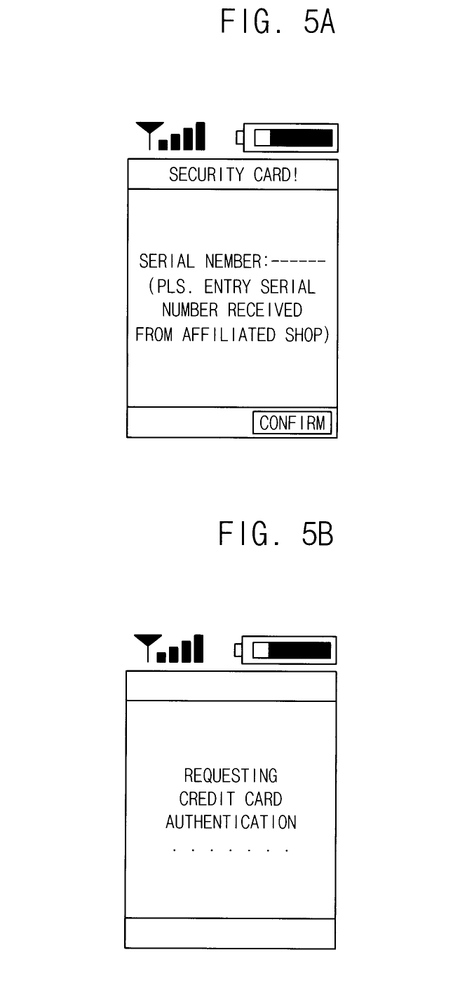

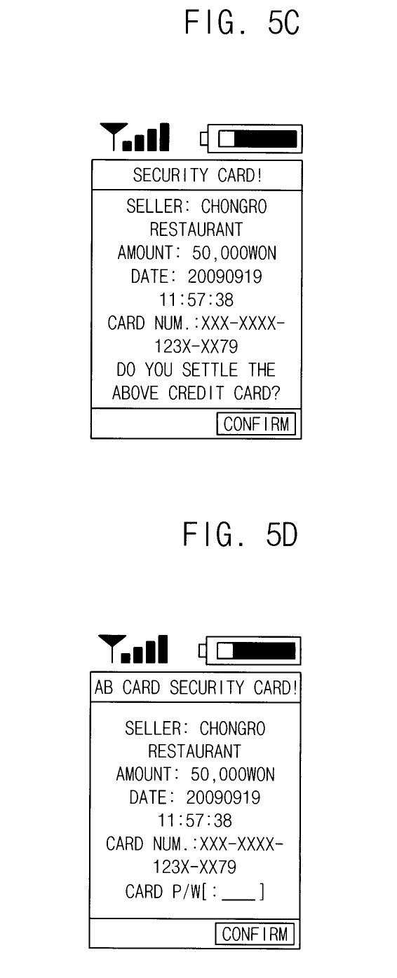

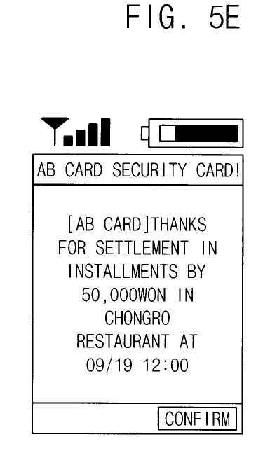

FIGS. 4A, 4B and 4C are flowcharts showing a settlement relay scenario in accordance with a settlement relay system according to another exemplary embodiment of the present invention. FIGS. 5A, 5B, 5C, 5D and 5E are images showing examples of a display screen of a mobile communication terminal.

Referring to FIGS. 1, 4A, 4B, 4C, 5A and 5B, a customer possessing the mobile communication terminal 200 requests a settlement to a manager of an affiliated shop in which an affiliated shop terminal 100 is installed (step S202).

Thus, a corresponding affiliated shop terminal 100 may print or generate a receipt, and then transmits a receipt serial number corresponding to the receipt that is printed or generated to the relay server 300 (step S204). The relay server 300 receives the receipt serial number of an affiliated shop, and then stores the received receipt serial number (step S206). The receipt serial number may include an affiliated shop name, a transaction amount, etc. Moreover, the affiliated shop terminal 100 may transmit the receipt to the mobile communication terminal 200 possessed to a customer (step S208). Alternatively, a manager of the affiliated shop may deliver the printed receipt to a customer possessing the mobile communication terminal 200.

The mobile communication terminal 200 drives a virtual machine (“VM”) program or an application program for a smart phone to transmit a settlement serial number to the relay server 300 by using the driven VM program or the application program for a smart phone (step S210). For example, as the mobile communication terminal 200 drives the VM program or the application program for a smart phone, a screen in FIG. 5A may be displayed on a corresponding mobile communication terminal 200. As a confirmation button displayed on a screen is clicked by a user, a message of a credit card authentication request as shown in FIG. 5B may be displayed on the screen of the mobile communication terminal.

When a settlement serial number of the mobile communication terminal 200 is received, the relay server 300 matches the received settlement serial number and the receipt serial number of an affiliated shop (step S212).

It is checked whether or not the received settlement serial number and the receipt serial number of an affiliated shop are matched (step S214). When the received settlement serial number and the receipt serial number of an affiliated shop are not matched with each other, the relay server 300 notifies that corresponding transaction settlement is not requested from an affiliated shop (step S216). Moreover, when the received settlement serial number and the receipt serial number of an affiliated shop are matched with each other, the relay server 300 requests whether or not a corresponding mobile communication terminal 200 is lost to a mobile communication company system 500.

As a signal requesting to check whether or not a corresponding mobile communication terminal 200 is lost received from the relay server 300, the mobile communication company system 500 inquires whether or not the corresponding mobile communication terminal 200 is lost, and then transmits the inquired result to the relay server 300 (step S218).

As a lost result data is received from the mobile communication company 500, the relay server 300 checks whether or not a corresponding mobile communication terminal 200 is the lost terminal (step S220). As a result, when it is checked that the corresponding mobile communication terminal is lost, the relay server 300 notifies with a transaction restraining message to a corresponding mobile communication terminal 200 (step S222). Moreover, the relay server 300 notifies with a transaction restraining message to the affiliated shop terminal 100 (step S222).

When it is checked that the corresponding mobile communication terminal 200 is not lost, the relay server 300 transmits a signal, which requests information including an affiliated shop name and a transaction amount and a credit card number or a mobile SSL client certificate for a corresponding transaction, to the mobile communication terminal 200 (step S226).

As an affiliated shop name and a transaction amount are provided from the relay server 300, the mobile communication terminal 200 displays the affiliated shop name and the transaction amount through a display window thereof (step S228). For example, as shown in FIG. 5C, the display window of the mobile communication terminal 200 may display an affiliated shop name capable of identifying a seller, a transaction amount information capable of identifying a settlement amount, a date information capable of identifying a settlement permission date, a credit card number capable of identifying a credit card company according to a corresponding settlement, etc.

Then, the mobile communication terminal 200 calls a user authentication page for a credit card company to the credit card company system 400 so as to settle a bill (step S230).

When a user authentication page for the credit card company is received, the credit card company system 400 requests an inputting of a credit card password or a mobile-authentication certificate password to the mobile communication terminal 200 (step S232). When the mobile communication terminal is a smart phone, the credit card company system 400 may not request the credit card password.

The mobile communication terminal 200 displays the request of the credit card password or the mobile-authentication certificate password. As a corresponding password is inputted by user, the mobile communication terminal 200 transmits the inputted password to the credit card company system 400 (step S234). For example, a display window of the mobile communication terminal 200 may display a screen as shown in FIG. 5D.

The credit card company system 400 confirms a credit card password or a mobile SSL client certificate that is inputted through the mobile communication terminal 200 to generate an authentication response full message data, and then transmits the generated authentication response full message data to the relay server 300 (step S236).

The relay server 300 receives a user authentication response from the credit card company system 400, and confirms whether or not the user authentication response is a normal (step S238).

It is checked whether or not it is a user authentication of a credit card, based on the received user authentication response (step S240).

In the step S240, when it is not checked that it is a user authentication of a credit card, the relay server 300 transmits a restraining message of a user authentication to the mobile communication terminal 200 (step S242).

In the step S240, when it is checked that it is a user authentication of a credit card, the relay server 300 request a settlement authentication to a credit card company system 400 (step S244).

The credit card company system 400 checks a credit of a corresponding transaction to transmit an approval response signal to the relay server 300 (step S246).

The relay server 300 receives an approval response signal from the credit card company system 400 to transmit the approval response signal to an affiliated shop terminal and a mobile communication terminal of a customer (step S248). The approval response signal transmitted to the mobile communication terminal 200 may be a short message service (“SMS”) message. For example, as shown in FIG. 5E, an SMS message, which informs a settlement amount, a settlement credit card and a settlement affiliated shop, may be transmitted to the mobile communication terminal 200.

The mobile communication terminal 200 receives a settlement approval SMS message provided from the relay server 300 to display the settlement approval SMS message (step S250). For example, the mobile communication terminal 200 may display a settlement approval SMS message as shown in FIG. 5E.

The affiliated shop terminal 100 outputs a receipt based on the settlement approval SMS message provided from the relay server 300 (step S252), and provides the receipt to a customer (step S254). When the receipt is printed in a piece of paper, the clerk may deliver the paper receipt to a customer. Alternatively, when the receipt is generated by an electric signal, the affiliated shop terminal 100 wirelessly transmits the receipt to the mobile communication terminal 200 of the customer.

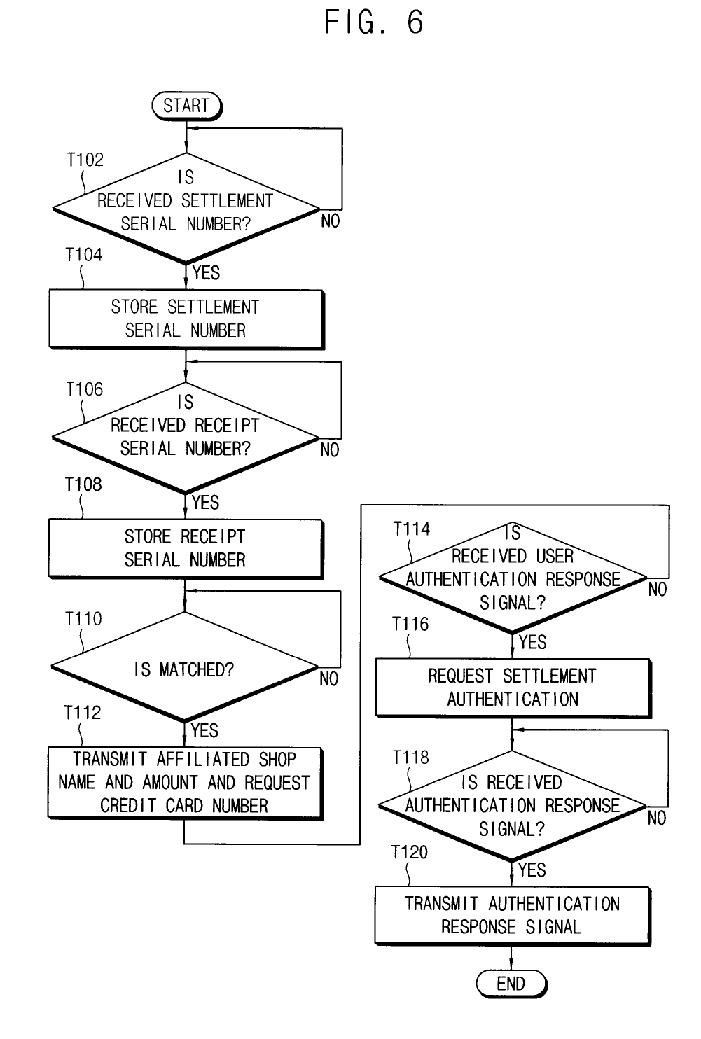

FIG. 6 is a flowchart showing a settlement relay method according to an exemplary embodiment of the present invention.

Referring to FIG. 6, it is checked whether or not a settlement serial number is received from a mobile communication terminal (step T102).

In the step T102, when it is checked that the settlement serial number is received, the received settlement serial number is stored (step T104).

Then, it is checked whether or not a receipt serial number is received from an affiliated shop terminal (step T106).

In the step T106, when it is checked that the receipt serial number is received, the received receipt serial number is stored (step T108).

Then, it is checked whether or not the receipt serial number and the settlement serial number are matched with each other (step T110).

In the step T110, when it is checked that the receipt serial number and the settlement serial number are matched with each other, the relay server 300 provides information such as an affiliated shop name, a transaction amount, etc., and requests an inputting of a credit card number or a mobile SSL client certificate to the mobile communication terminal (step T112). Thus, the mobile communication terminal of a customer may progress a series of procedure in which a corresponding credit card number is inputted thereto.

Then, the relay server 300 checks whether or not a user authentication response signal is received from a credit card company system (step T114).

In the step T114, when it is checked that a user authentication response signal is received from a credit card company system, the relay server 300 requests a settlement authentication to a corresponding credit card company system (step T116).

Then, the relay server 300 checks whether or not an authentication response signal is received from a corresponding credit card company system (step T118).

In the step T118, when it is checked that the authentication response signal is received from a corresponding credit card company system, the relay server 300 transmits the authentication response signal to the affiliated shop terminal and the mobile communication terminal (step T120).

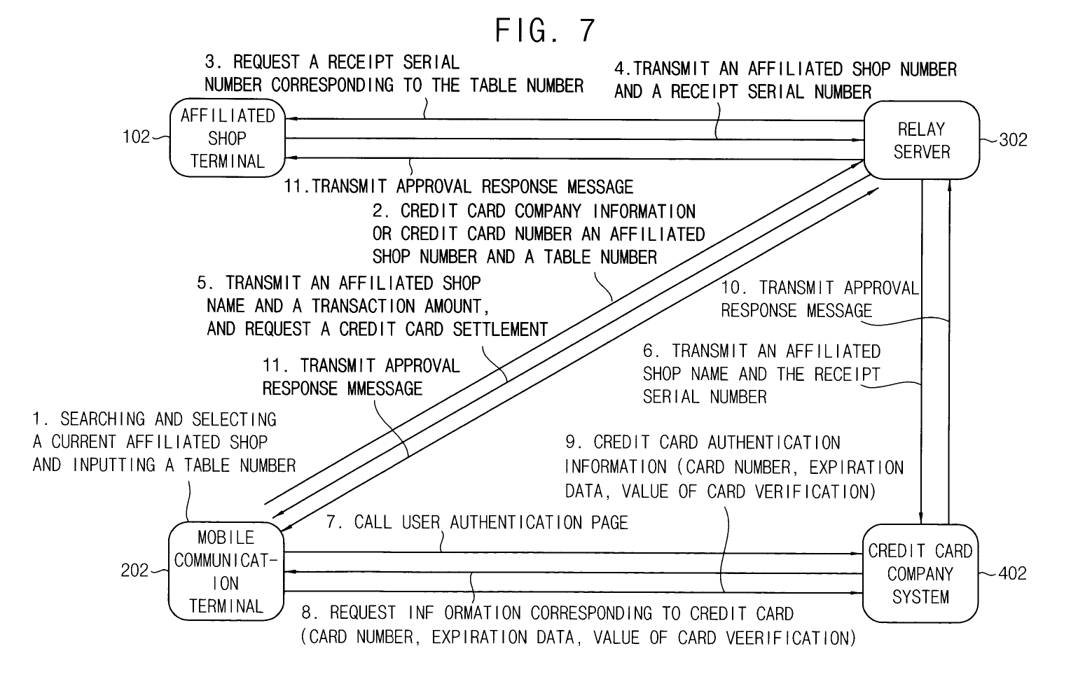

FIG. 7 is a conceptual diagram illustrating a settlement relay system according to another exemplary embodiment of the present invention. For example, FIG. 7 shows a settlement relay system performing a method of relaying a charge settlement by using a table number.

Referring to FIG. 7, a settlement relay system according to another exemplary embodiment of the present invention may be explained by an affiliated shop terminal 102, a mobile communication terminal 202, a relay server 302 and a credit card company system 402.

When a search for current affiliated shops is requested in accordance with an operation of user, the mobile communication terminal 202 searches the current affiliated shops, and displays information for the searched affiliated shops on a screen thereof. When the user selects one of affiliated shops displayed thereon, the mobile communication terminal 202 displays a window for inputting a table number to receive the table number in accordance with an operation of the user.

Then, the mobile communication terminal 202 transmits a number capable of identifying a credit card company, an affiliated shop number and the table number to the relay server 302. In this case, the number capable of identifying the credit card company may be credit card company information or a credit card number, etc.

Then, the relay server 302 requests a receipt serial number corresponding to the table number to the affiliated shop terminal 102.

Then, the affiliated shop terminal 102 transmits an affiliated shop number and a receipt serial number to the relay server 302.

Then, the relay server 302 transmits an affiliated shop name corresponding to the affiliated shop number and a transaction amount to the mobile communication terminal 202 to request that corresponding information is displayed on the mobile communication terminal 202, and requests a credit card settlement to the mobile communication terminal 202. The relay server 302 transmits the affiliated shop number and the receipt serial number to the credit card company system 402.

Then, the mobile communication terminal 202 calls a user authentication page to request an authentication process to the credit card company system 402.

Then, the credit card company system 402, which is received a request of calling of a user authentication page and authentication process from the mobile communication terminal 202, requires an inputting of information for a corresponding credit card to the customer. The information for the corresponding credit card may include a password of a mobile-SSL client certificate or a card number, an expiration data, a value of a card verification, etc.

Then, the mobile communication terminal 202 provides the credit card company system 402 with information for certifying a credit card inputted in accordance with an operation of the user. The information for certifying a credit card may include a password of a mobile-SSL client certificate or a credit card number, an expiration data, a value of a card verification, etc. For example, when the credit card is Visa Credit Card, the value of the card verification may be a verification value (CVV). When the credit card is Master Credit Card, the value of the card verification may be a card validation code (CVC). When the credit card is American Express Credit Card, the value of the card verification may be a confidential identifier number (or card identification number: CID).

When the credit card company system 402 receives a settlement authentication request, the credit card company system 402 checks a settlement loan for a corresponding credit card. When it is checked that the corresponding credit card has a settlement loan, the credit card company system 402 transmits an approval response signal to the relay server 302.

When the relay server 302 receives the approval response signal, the relay server 302 transmits an approval response result to the affiliated shop terminal 102 and the mobile communication terminal 202.

Accordingly, the affiliated shop terminal 102 may confirm that a settlement for a corresponding transaction is finished, and the mobile communication terminal 202 may confirm that a settlement for the corresponding transaction is finished.

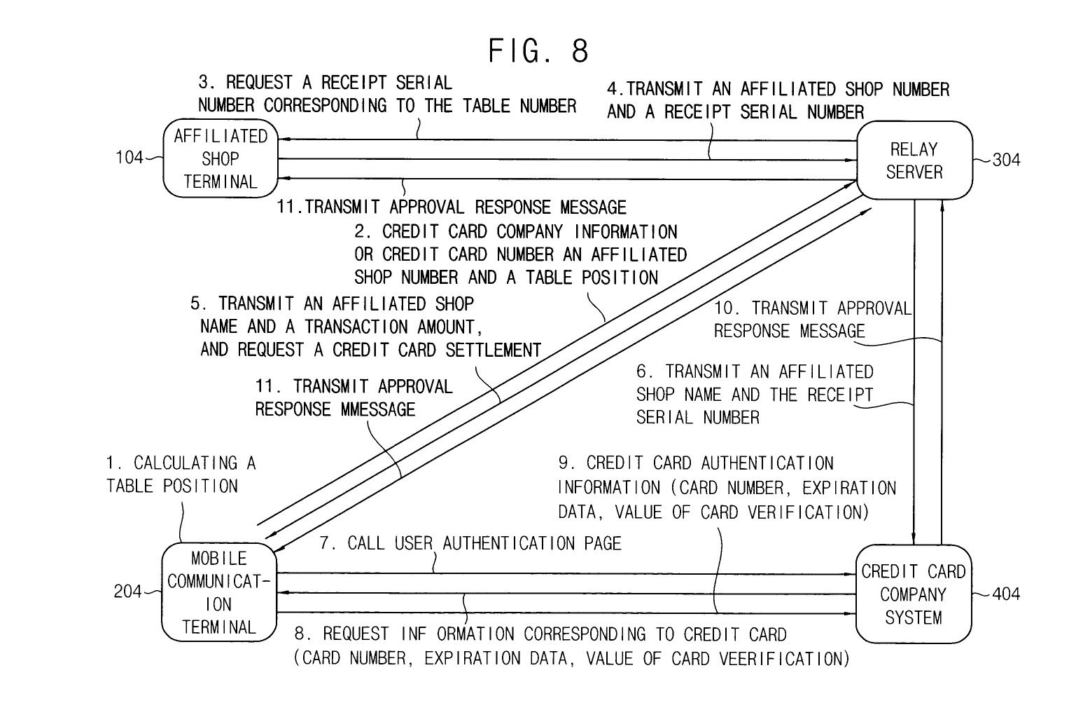

FIG. 8 is a conceptual diagram illustrating a settlement relay system according to still another exemplary embodiment of the present invention. For example, FIG. 8 shows a settlement relay system performing a method of relaying a charge settlement by using a table position.

Referring to FIG. 8, a settlement relay system according to another exemplary embodiment of the present invention may be explained by an affiliated shop terminal 104, a mobile communication terminal 204, a relay server 304 and a credit card company system 404.

The mobile communication terminal 204 calculates a table position in accordance with an operation of the user. A calculation of the table position by the mobile communication terminal 204 may be performed in a distance calculation using a first access point (AP1: not shown) that is embedded in the affiliated shop terminal 104 or disposed adjacent to the affiliated shop terminal 104, and a second access point (AP2: not shown) that is disposed far away from the affiliated shop terminal 104 within an affiliated shop area on which the affiliated shop terminal 104 is disposed. According to the calculation of the table position, the affiliated shop terminal 104 may confirm a position of the corresponding mobile communication terminal 204.

Hereinafter, operations of the affiliated shop terminal 104, the mobile communication terminal 204, the relay server 304 and the credit card company system 404 may be substantially the same as the operations of the affiliated shop terminal 102, the mobile communication terminal 202, the relay server 302 and the credit card company system 402. Thus, a detailed description thereof will be omitted.

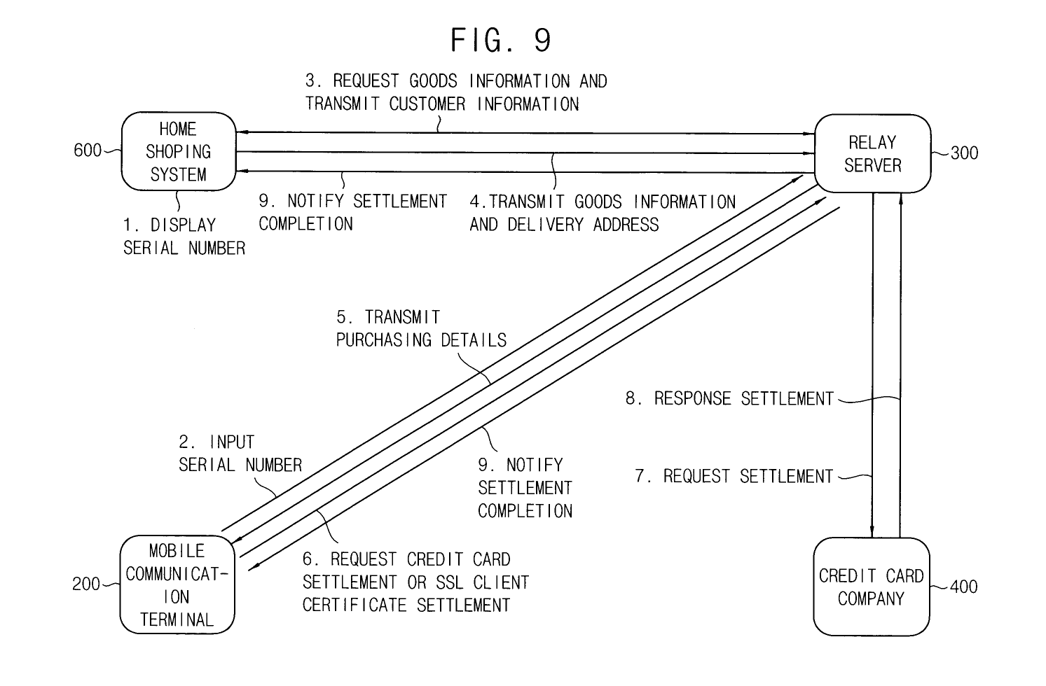

FIG. 9 is a conceptual diagram illustrating a settlement relay system according to another exemplary embodiment of the present invention.

Referring to FIG. 9, a settlement system according to another exemplary embodiment may be explained by a home shopping system 600, a mobile communication terminal 200, a relay server 300 and a credit card company system 400.

The home shopping system 600 advertises goods for purchasing to display a serial number for corresponding goods. The serial number may be displayed in a bar code type or a QR code type. The serial number may include information such as a particle number, an affiliated shop name, goods, etc. In this exemplary embodiment, the home shopping system 600 may be an automated response system (“ARS”) shopping network, a television (TV) home shopping network, an online shopping network, etc.

In order to purchase goods advertised, a user drives a VM or an application program for a smart phone embedded in the mobile communication terminal 200 to input a serial number of goods. Then, the mobile communication terminal transmits the serial number inputted through clicking an internet access button to the relay server 300. For one example, when the serial number of goods is display in a bar code type, a user may scan the bar code through the mobile communication terminal 200. The scanned bar code may be transmitted to the relay server 300. For another example, when the serial number of goods is display in a QR code type, a user may scan or photograph the QR code through the mobile communication terminal 200. The scanned or photographed QR code may be transmitted to the relay server 300.

The relay server 300 receives a corresponding matter provided from the mobile communication terminal to transmit corresponding goods information to the home shopping system 500. Moreover, the relay server 300 may transmit corresponding customer information to the home shopping system 500. The customer information may include delivery address information that is set by a customer.

The relay server 300 transmits purchase details, for example, goods information, transaction amount information, delivery address information, etc., to the mobile communication terminal 200 to request an inputting of a purchase amount and settlement information to a corresponding mobile communication terminal 200.

A customer confirms goods details and price per unit of the goods that are displayed on a mobile communication terminal, and requests a credit card settlement or SSL client certificate settlement to the relay server 300 so as to provide the relay server 300 with settlement information corresponding to a purchase quantity. According to one example, the mobile communication terminal may request a credit card settlement by inputting a BIN of a credit card and a price. According to another example, the mobile communication terminal may request a mobile SSL client certificate settlement by transmitting a mobile-SSL client certificate including an encoded credit card number with a SSL client certificate to the relay server 300. A description for the mobile SSL client certificate will be described latter.

The relay server 300 requests a settlement corresponding to purchasing goods by a corresponding customer to a credit card company system 400 corresponding to a credit card provided from the mobile communication terminal, in response to the credit card settlement or the mobile SSL client certificate settlement. The corresponding credit card company system 400 transmits a settlement response corresponding to the settlement to the relay server 300. The relay server 300 receiving the settlement response notifies a settlement completion to the home shopping system 600 and the mobile communication terminal 200.

In this exemplary embodiment, the relay server 300 may be realized by a communication part (not shown) and a system control part (not shown). The communication part is connected to the home shopping system 600, the mobile communication terminal 200 and the credit card company system 400 through a communication network.

The system control part may be designed to receive and store a serial number of goods advertized at the home shopping system 600 from the mobile communication terminal 200 through the communication module and to transmit corresponding goods and customer information provided from the mobile communication terminal 200 to the home shopping system 600 through the communication part. The system control part may be designed to request a credit card number data to the mobile communication terminal 200 when a purchase quantity and settlement information are received from the mobile communication terminal 200. The system control part may be designed to receive an authentication response full message data from the credit card company system 400, which is generated by confirming the credit card number by the credit card company system 400 after the credit card number is inputted through the mobile communication terminal 200. The system control part may be designed to transmit a settlement authentication to a corresponding credit card company system 400 when the authentication response full message data is checked as a user authentication of a corresponding mobile communication terminal 200. The system control part may be designed to transmit an authentication response to the home shopping system 600 when the authentication response is received from the credit card company system 400.

The relay server 300 according to the present embodiment may be realized by a configuration of various hardware components. For example, the relay server 300 may be realized in a similar manner such as a configuration described in FIG. 2. Thus, any repetitive detailed description thereof will hereinafter be omitted.

In the above exemplary embodiment, as a customer who wants to purchase goods advertised at the home shopping system requests a purchase through a mobile communication terminal, the relay server determines a corresponding purchase is a small sum settlement based on a BIN and a transaction amount that are provided from the corresponding mobile communication terminal of the user to perform a settlement process in accordance with a No Authentication Required transaction.

Hereinafter, it will be explained that the relay server determines a corresponding purchase is a small sum settlement or a large sum settlement based on a BIN and a transaction amount that are provided from a corresponding mobile communication terminal of a user to perform a settlement process in accordance with a No Authentication Required transaction or an Authentication Required transaction, when a customer who wants to purchase goods advertised at the home shopping system requests a purchase through a mobile communication terminal.

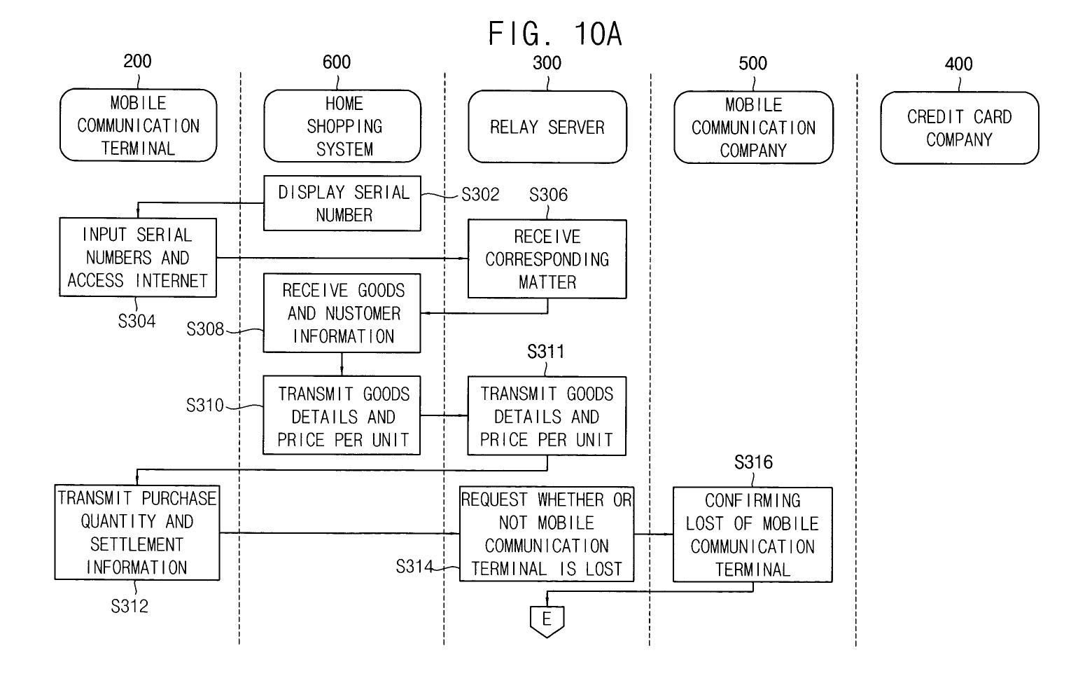

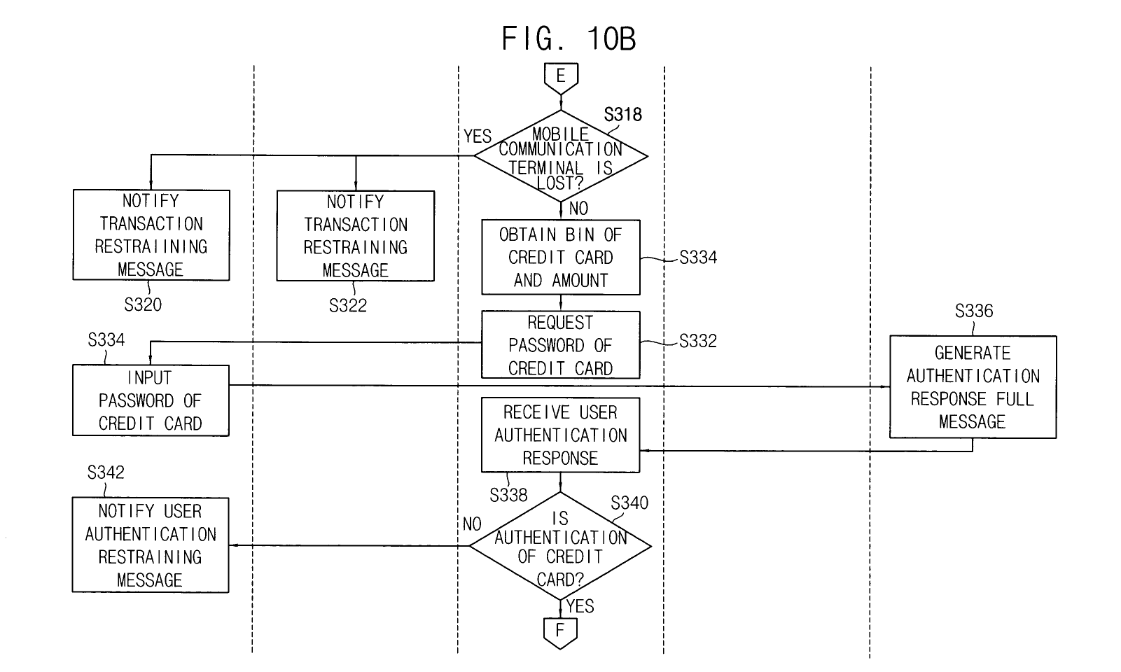

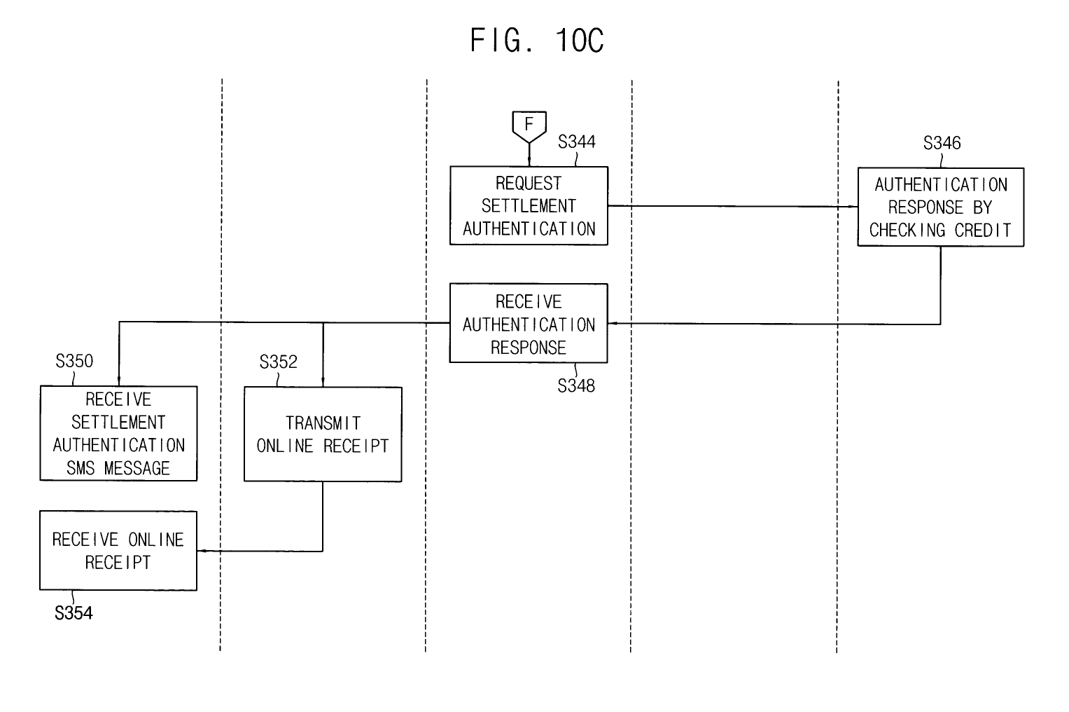

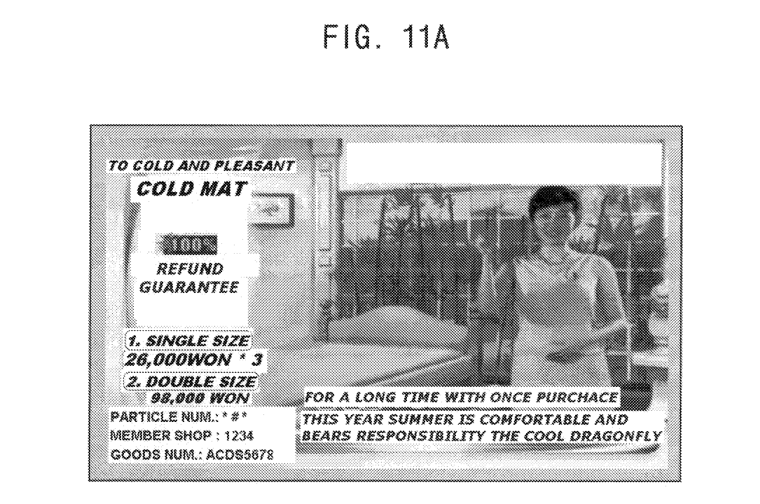

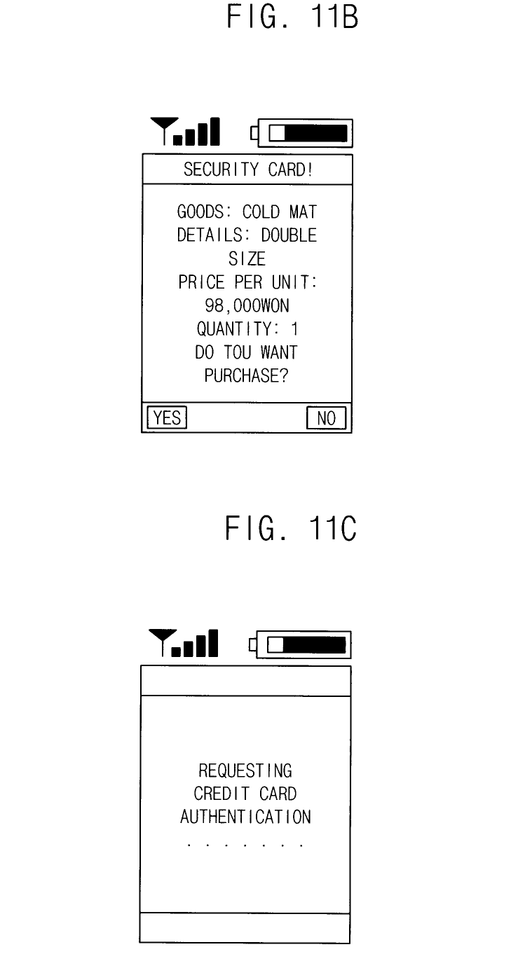

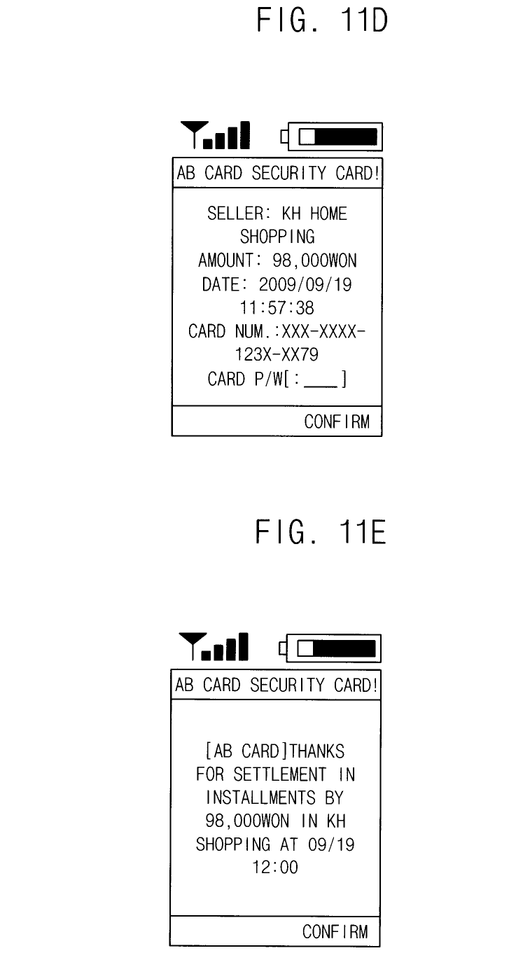

FIGS. 10A, 10B and 10C are flowcharts showing a settlement relay scenario in accordance with a settlement relay system according to another exemplary embodiment of the present invention. FIGS. 11A, 11B, 11C, 11D and 11E are images showing examples of a display screen of a mobile communication terminal.

Referring to FIGS. 10A to 10C, the home shopping system 600 advertises goods for purchasing to display a serial number for corresponding goods (step S302). The serial number may be displayed in a bar code type or a QR code type. The serial number may include information such as a particle number, an affiliated shop code, a goods number, etc. For example, as shown in FIG. 11A, <*#*> as the particle number, <1234> as the affiliated shop code, and <ACDS5678> as the goods number may be displayed on a screen of a TV. In this exemplary embodiment, the particle number may represent a button of a mobile communication terminal for requesting a purchase, the affiliated shop code may represent an inherent number of a corresponding home shopping company, and the goods number may represent an inherent number of goods being on air.

The customer inputs a serial number by using a mobile communication terminal 200, and then clicks an internet access button, etc., to transmit the inputted serial number to a relay server 300 (step S304). For example, the inputted serial number may be <*#*1234ACDS5678>. For one example, when the serial number of goods is display in a bar code type, a user may scan the bar code through the mobile communication terminal 200. The scanned bar code may be transmitted to the relay server 300. For another example, when the serial number of goods is display in a QR code type, a user may scan or photograph the QR code through the mobile communication terminal 200. The scanned or photographed QR code may be transmitted to the relay server 300.

The relay server 300 receives a corresponding matter to transmit corresponding goods information and customer information to a home shopping system 600 (step S306). The corresponding goods information may include information inputted by a customer, and the customer information may include phone number information of a customer.

The home shopping system 600 receives corresponding goods and a customer information provided from the relay server 300 (step S308), and then transmit purchase details of corresponding goods and the price per unit of the corresponding goods (step S310). Thus, the relay server 300 transmits information such as corresponding goods price, a delivery address, etc., to a mobile communication terminal 200 (step S311).

The mobile communication terminal 200 receives the details of the corresponding goods and the price per unit of the corresponding goods from the relay server 300 to display information as shown in FIG. 11B (step S310).

A customer possessing the mobile communication terminal 200 confirms goods details and price per unit of the goods that are displayed on the mobile communication terminal 200, and enters a purchase quantity and settlement information on the mobile communication terminal 200. Thus, the mobile communication terminal 200 transmits the inputted purchase quantity and settlement information to the relay server 300 (step S312). Therefore, as shown in FIG. 11C, a screen displaying a message such as “requesting credit card authentication . . . ” may be display on the mobile communication terminal 200. In addition, the customer may further select or enter delivery address information on the mobile communication terminal 200. In this exemplary embodiment, a process that the user selects one of the credit cards to request a settlement through the selected credit card is omitted. However, an additional screen for asking which credit card to perform the settlement may further displayed on the mobile communication terminal 200.

As a purchase quantity and settlement information is transmitted from the mobile communication terminal 200, the relay server 300 transmits a request for inquiring whether or not the mobile communication terminal 200 is lost to the mobile communication company system 500 (step S314).

A mobile communication company system 500 inquires whether or not a corresponding mobile communication terminal 200 is lost (step S316), and transmits a result of the inquiring to the relay server 300.

The relay server 300 checks whether or not a corresponding mobile communication terminal 200 is lost (step S318).

In the step S318, when it is checked that the mobile communication terminal 200 is lost, the relay server 300 notifies with a transaction restraining message to a corresponding mobile communication terminal 200 (step S320), and notifies with a transaction restraining message of a corresponding mobile communication terminal to a home shopping system 600 (step S322). In this exemplary embodiment, it was described that a step of notifying with a transaction restraining message to a corresponding mobile communication terminal 200 is included; however, the above step may be omitted.

In the step S318, when it is checked that the mobile communication terminal 200 is not lost, a BIN of the credit card and a transaction amount that are inputted are obtained (step S324).

Then, the relay server 300 requests a password of the credit card to the mobile communication terminal 200 (step S332).

As the mobile communication terminal 200 receives a request of a password of a credit card from the relay server 300, the mobile communication terminal 200 displays the request on a display window thereof. Then, the mobile communication terminal 200 displays a display window thereof for inputting a password of a credit card by requesting a mobile page provided from a credit card company system 400 or calling a mobile page stored therein. As the password of a credit card is inputted by a user, the mobile communication terminal 200 transmits the inputted password to the credit card company system 400 (step S334). For example, as shown in FIG. 11D, a screen for inputting a password of a corresponding credit card may be displayed thereon with information such as a time for a settlement, a kind of a credit card, a transaction amount and a name of a home shopping network.

As the password of a credit card is received from the mobile communication terminal 200, the credit card company system 400 confirms the inputted password to generate an authentication response full message data based on the inputted password, and then transmits the generated authentication response full message data to the relay server 300 (step S336).

The relay server 300 receives a user authentication response from the credit card company system 400 (step S338).

Then, the relay server 300 checks whether or not a user authentication of a credit card is verified (step S340).

In the step S340, when a user authentication is not checked, the relay server 300 notifies with a user authentication restraining message to the mobile communication 200 (step S340).

In the step S340, when a user authentication is checked, the relay server 300 requests a settlement authentication to a credit card company (step S344).

Then, as a settlement authentication is requested from the relay server 300, the credit card company system 400 checks a credit of a corresponding settlement to generate an authentication response message, and then transmits the generated authentication response message to the relay server 300 (step S346). In addition, the credit card company system 400 may further transmit an additional SMS message for confirming a time of a settlement, a kind of a credit card, a transaction amount and a name of a home shopping network.

Then, the relay server 300 receives an authentication response message to transmit a result of an authentication response to the home shopping system 600 and the mobile communication terminal 200 (step S348). The result of an authentication response transmitted from the relay server 300 may be a message which authorizes a corresponding transaction. For example, the authentication response message provided from the mobile communication terminal 200 may be an SMS message.

The mobile communication terminal 200 receives a settlement SMS message from the relay server 300 (step S350).

Moreover, the home shopping system 600 confirms a result of an authentication response provided from the relay server 300 to transmit an online receipt to the mobile communication terminal 200 (step S352), and the mobile communication terminal 200 receives the online receipt from the home shopping system 600 (step S354).

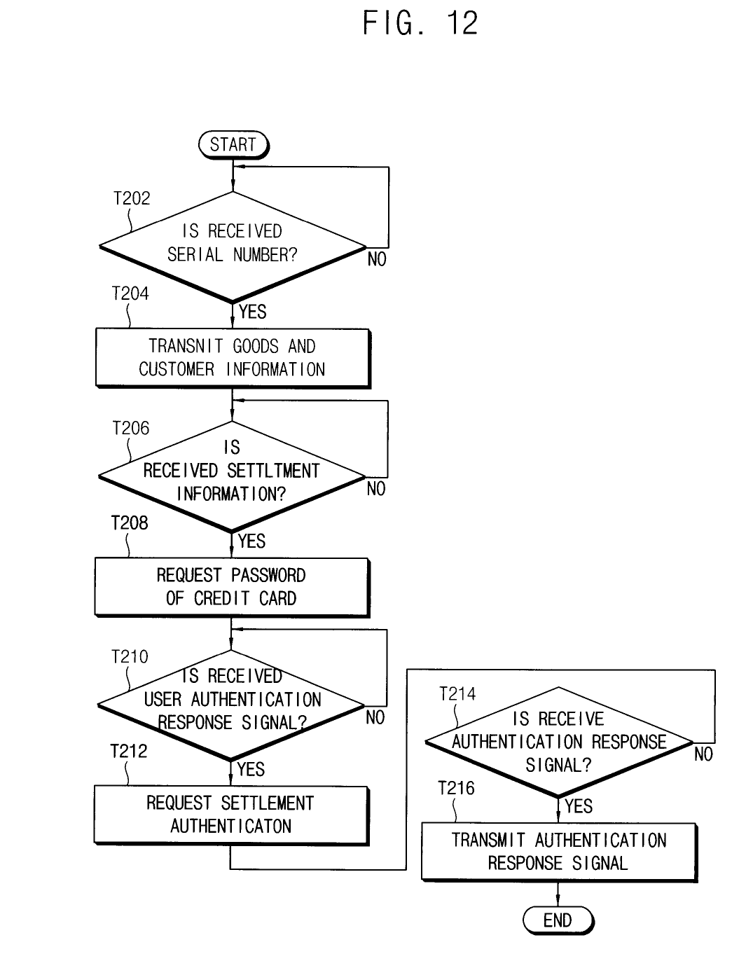

FIG. 12 is a flowchart showing a settlement relay method according to another exemplary embodiment of the present invention.

Referring to FIG. 12, a relay server checks whether or not a serial number is received from a mobile communication terminal (step T202).

In the step T202, when it is checked that the serial number is received, the relay server transmits corresponding goods and customer information to a home shopping system (step T204).

Then, the relay server checks whether or not settlement information is received from a mobile communication terminal (step T206).

In the step T206, when it is checked that settlement information is received, the relay server requests an inputting of a password of a credit card or a password of a mobile SSL client certificate to the mobile communication terminal 200 (step T208).

Then, the relay server checks whether or not a user authentication response signal is received from a credit card company system (step T210).

In the step T210, when it is checked that the user authentication response signal is received from the credit card company system, the relay server requests a settlement authentication to a corresponding credit card company (step S212).

Then, the relay server checks whether or not an authentication response signal is received from a corresponding credit card company system (step T214).

In the step T214, when it is checked that the authentication response signal is received from the corresponding credit card company system, the relay server transmits the authentication response signal to the affiliated shop terminal and the mobile communication terminal (step T216).

In this exemplary embodiment, a home shopping system such as a TV home shopping system simultaneously advertizing goods or services to a plurality of potential purchasers is described as an example; however, it may be adapted to another service system. That is, it may be adapted to an affiliated shop system such as a restaurant. For example, when a user receiving food at a restaurant requests a settlement in an inputting an affiliated shop code and a service code (for example, a table code) by using his/her own mobile communication terminal, a relay server requests an inquiry of service details to a corresponding affiliated shop terminal by using a corresponding affiliated shop code. In this case, since the affiliated shop code and the service code are inputted through the mobile communication terminal of the user, a confirmation of a predetermined affiliated shop may be possible and a confirmation request of a corresponding service may be possible based on the table code. The affiliated shop terminal checks whether or not a corresponding affiliated shop code is available, and transmits details corresponding to the service details, for example, a price information (in addition, a service name may be further included) to the relay server. For one example, the affiliated shop terminal may automatically check the service details to transmit the result of the service details to the relay server. For another example, when the affiliated shop terminal automatically checks the service details, the affiliated shop may transmit the service details to the relay server, which are manually inputted by an operation of an affiliated shop manager.

Although not shown in FIG. 12, the relay server may further perform a process by transmitting a price for a corresponding service or a price and a service name for a corresponding service to a user mobile communication terminal and receiving settlement information provided in accordance with an operation of the mobile communication terminal, and an authentication process, etc. A process receiving settlement information in accordance with an operation of the mobile communication terminal and an approval process were described in exemplary embodiments of the present invention, so that any detailed description thereof will hereinafter be omitted.

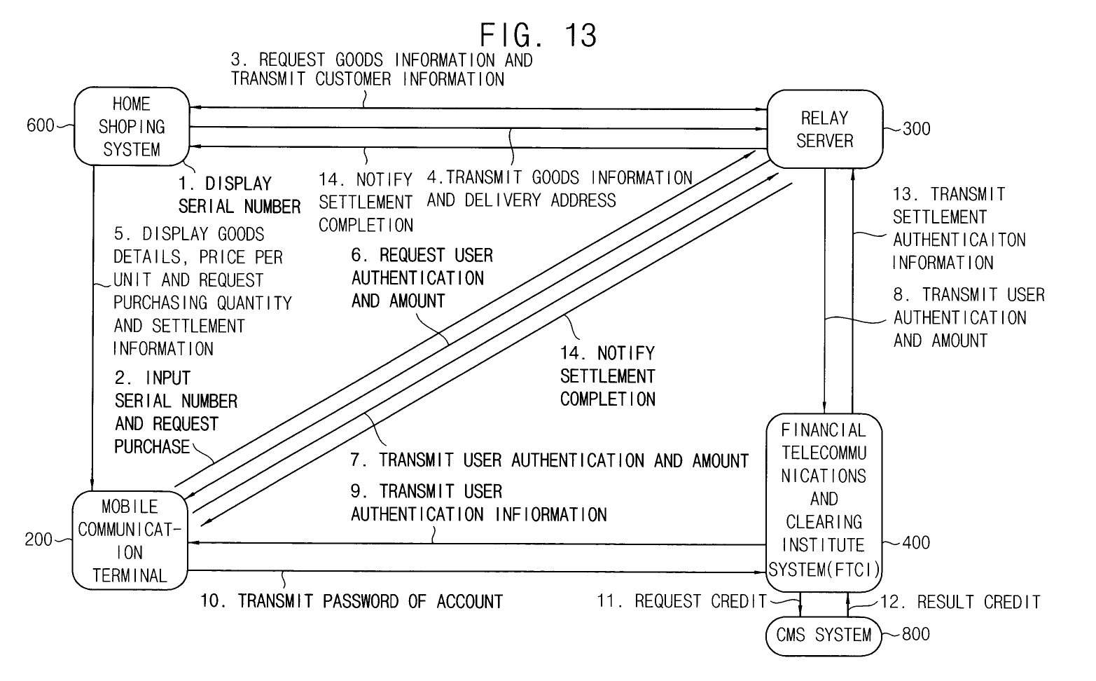

FIG. 13 is a conceptual diagram illustrating a settlement relay system according to still another exemplary embodiment of the present invention.

Referring to FIG. 13, a settlement system according to still another exemplary embodiment may be explained by a home shopping system 600, a mobile communication terminal 200, a relay server 300, a financial telecommunications and clearings institute (hereinafter, referred to as “FTCI”) 700 and a cash management service (hereinafter, referred to as “CMS”) system 800.

The home shopping system 600 advertises goods for sales to display a serial number for corresponding goods. The serial number may include information such as a specific number, an affiliated shop name, goods, etc.

In order to purchase goods advertised, a user drives a VM or an application program for a smart phone embedded in the mobile communication terminal 200 to input a serial number of goods. Then, the mobile communication terminal transmits the serial number inputted through a clicking of an internet access button to a relay server 300.

The relay server 300 receives a corresponding matter provided from the mobile communication terminal to transmit corresponding goods information to the home shopping system 500. Moreover, the relay server 300 may transmit corresponding customer information to the home shopping system 500. The customer information may include a phone number of the mobile communication of a customer.

The home shopping system 600 provides a corresponding mobile communication terminal 200 with goods details, price per unit of goods on the basis of customer information provided from the relay server 300, and requests an inputting of a purchase quantity of settlement information to a corresponding mobile communication 200.

In this case, the relay server 300 may request user authentication information and price information to a corresponding mobile communication terminal 200.

A customer confirms goods details and price per unit of the goods that are displayed on a mobile communication terminal, and transmits user authentication information and price information to the relay server 300 so as to provide the relay server 300 with settlement information corresponding to a wanted purchase quantity.

The relay server 300 transmits user authentication information and price information that are provided from the mobile communication terminal 200 to the FTCI 700.

The FTCI 700 transmits user authentication information to the mobile communication terminal 200, and then receives a password of an account from the mobile communication terminal 200.

The FTCI 700, which receives the password of the account, requests a credit inquiry corresponding to the account to the CMS system 800.

The CMS system 800 inquires a credit status of a corresponding account in response to an inquiry of the FTCI 700, and provides the FTCI 700 with the result of the inquiry.

The FTCI 700 transmits settlement approval information to the relay server 300 based on the result of the credit inquiry that is provided from the CMS system 800. For example, when it is checked that the credit status of the corresponding account is favorable, the FTCI 700 may provide the relay server 300 with information that a credit status of the corresponding account is favorable. Meanwhile, when it is checked that the credit status of the corresponding account is unfavorable, the FTCI 700 may provide the relay server 300 with information that a credit status of the corresponding account is unfavorable.

As settlement approval information is provided from the FTCI 700, the relay server 300 transmits a settlement completion notification to the home shopping system 600 and the mobile communication terminal 200.

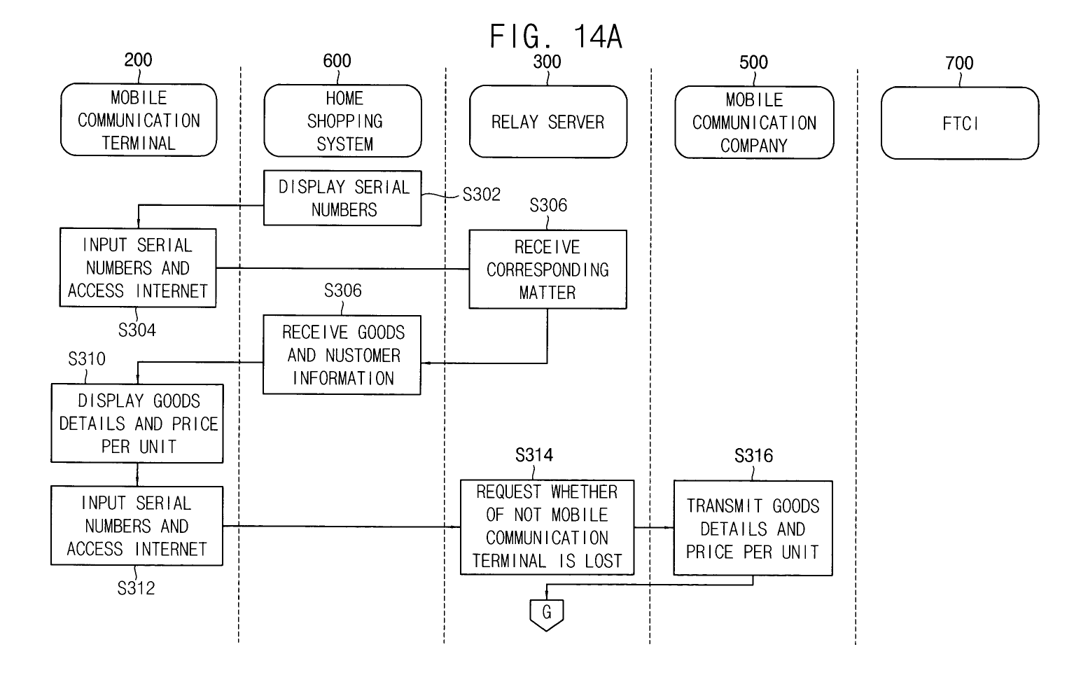

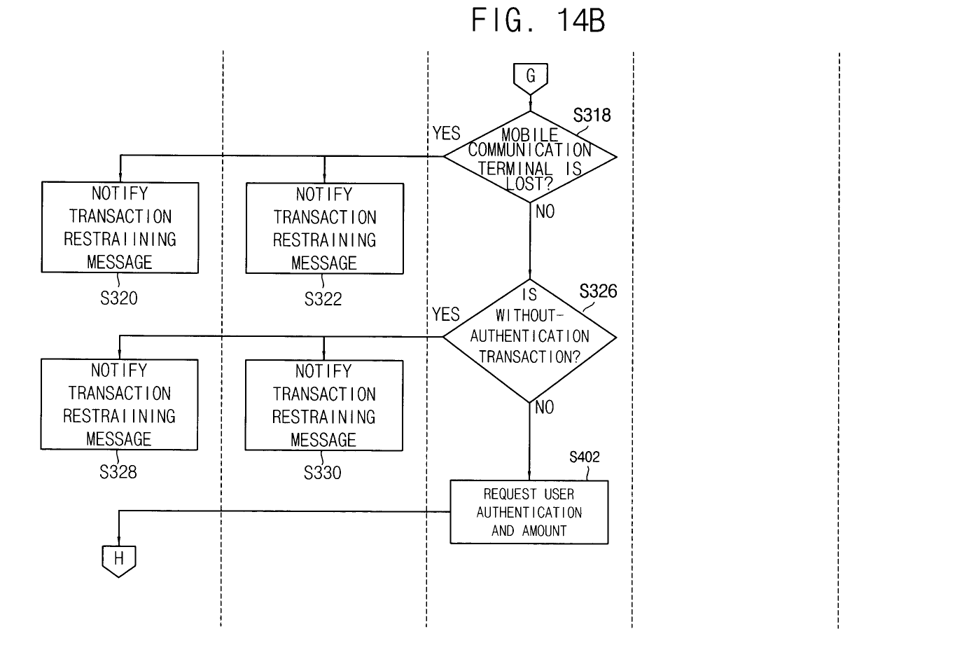

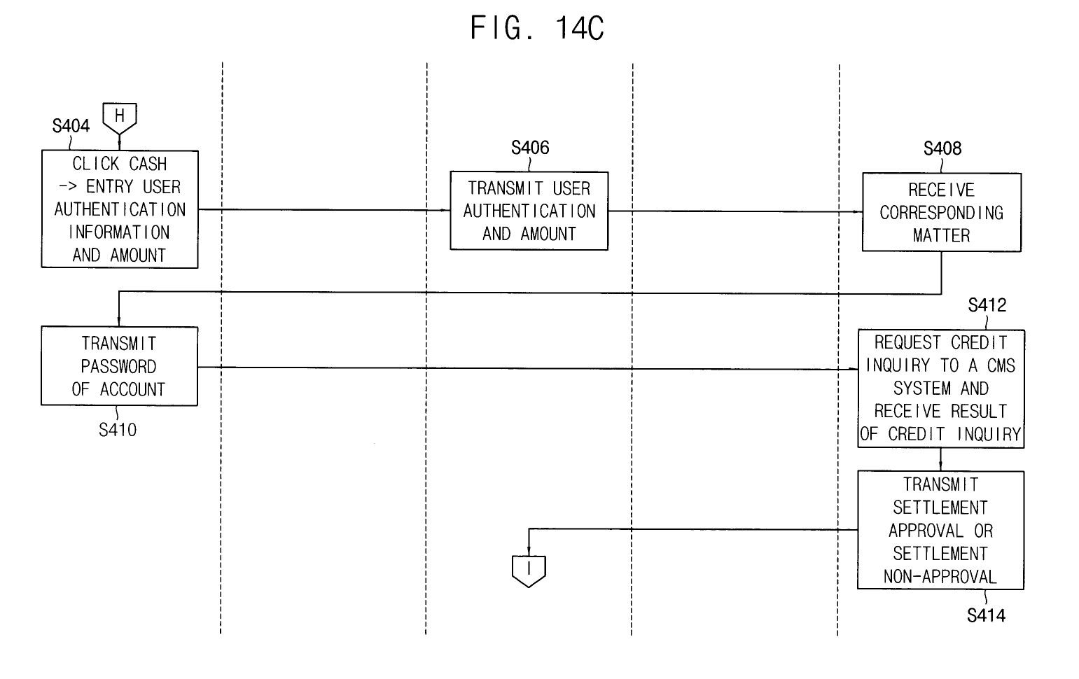

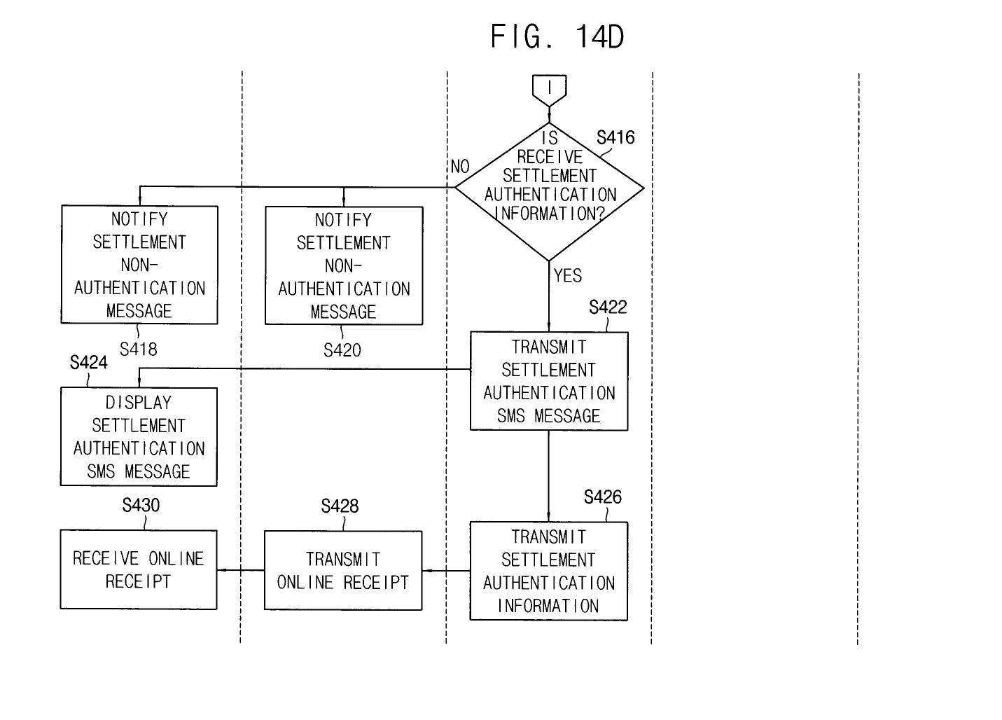

FIGS. 14A, 14B, 14C and 14D are flowcharts showing a settlement relay scenario described in FIG. 13.

Referring to FIGS. 14A to 14D, the home shopping system 600 advertises goods for purchasing to display a serial number for corresponding goods (step S302). The serial number may include information such as a particle number, an affiliated shop code, a goods number, etc. For example, as shown in FIG. 11A, <*#*> as the particle number, <1234> as the affiliated shop code, and <ACDS5678> as the goods number may be displayed on a screen of a TV. In this exemplary embodiment, the particle number may represent a button of a mobile communication terminal for requesting a purchase, the affiliated shop code may represent an inherent number of a corresponding home shopping company, and the goods number may represent an inherent number of goods being on air.

The customer inputs a serial number by using a mobile communication terminal 200, and then clicks an internet access button, etc., to transmit the inputted serial number to a relay server 300 (step S304). For example, the inputted serial number may be <*#*1234ACDS5678>.

The relay server 300 receives a corresponding matter to transmit corresponding goods information and customer information to a home shopping system 600 (step S306). The corresponding goods information may include information inputted by a customer, and the customer information may include phone number information of a customer.

The home shopping system 600 receives corresponding goods and customer information provided from the relay server 300, and transmits details of corresponding goods and the price per unit of the corresponding goods (step S308). Thus, the relay server 300 transmits information such as corresponding goods details, a price per unit, etc., to a mobile communication terminal 200 (step S311).

The mobile communication terminal 200 receives the details of the corresponding goods and the price per unit of the corresponding goods from the home shopping system 600 to display information as shown in FIG. 11B (step S310).

A customer possessing the mobile communication terminal 200 confirms goods details and price per unit of the goods that are displayed on the mobile communication terminal 200, and enters a purchase quantity and settlement information on the mobile communication terminal 200. Thus, the mobile communication terminal 200 transmits the inputted purchase quantity and settlement information to the relay server 300 (step S312). In addition, the customer may further select or enter delivery address information on the mobile communication terminal 200.

As a purchase quantity and settlement information is transmitted from the mobile communication terminal 200, the relay server 300 transmits a request for inquiring whether or not the mobile communication terminal 200 is lost to the mobile communication company system 500 (step S314).

The mobile communication company system 500 checks whether or not the corresponding mobile communication terminal 200 is lost (step S316), and transmits the result thereof to the relay server 300.

The relay server 300 checks that the corresponding mobile communication 200 is lost or not (step S318).

In the step S318, when it is checked that the corresponding mobile communication terminal 200 is lost, the relay server 300 notifies with a transaction restraining message to the mobile communication terminal 200 (step S320), and notifies with a transaction restraining message to the home shopping system 600 (step S322). In this exemplary embodiment, it was described that a step of notifying with the transaction restraining message is included; however, the above step may be omitted.

In the step S318, when it is checked that the corresponding mobile communication terminal 200 is not lost, the relay server 300 checks whether or not the corresponding transaction is a No Authentication Required transaction (step S326).

In the step S326, when it is checked that the corresponding transaction is a No Authentication Required transaction, the relay server 300 sends a corresponding transaction success message according to the No Authentication Required transaction to the mobile communication terminal 200, and the mobile communication terminal 200 receives the transaction success message according to the No Authentication Required transaction to display the transaction success message thereon (step S328). Moreover, the relay server 300 notifies with the transaction success message according to the No Authentication Required transaction to the home shopping system 600, and the home shopping system 600 receives the transaction success message (step S330). The mobile communication terminal 200 or the home shopping system 600 may confirm that a corresponding transaction is normally completed through the step S328 or the step S330. Although not shown in FIGS. 14A to 14C, as the No Authentication Required transaction is completed, the home shopping system 600 may ask a financial company (i.e., a bank company) of a corresponding customer to pay an amount charged according to a corresponding transaction.

In the step S326, when it is checked that the corresponding transaction is a No Authentication Required transaction, the relay server 300 requests user authentication information and price information to the mobile communication terminal 200 (step S402).

As an input of user authentication information and price information are requested from the relay server 300, the mobile communication terminal 200 displays a request of the input to enter the user authentication information and price information by clicking of a cash button in accordance with an operation of user (step S404). Accordingly, the relay server 300 receives the authentication information and the price information to transmit the authentication information and the price information to the FTCI 700 (step S406).

As user authentication information and price information are provided from the relay server 300, the FTCI 700 requests a password of an account to the mobile communication terminal 200 (step S408).

Thus, the mobile communication terminal 200 transmits the password of the account to the FTCI 700 in accordance with an operation of user (step S410).

The FTCI 700 requests a credit inquiry to the CMS system 800 to receive the result of the credit inquiry (step S412), and transmits a settlement approval information or a settlement non-approval information to the relay server 300 (step S414).

The relay server 300 checks whether the information provided from the FTCI 700 is settlement approval information or settlement non-approval information (step S416).

In the step S416, when it is checked that the settlement non-approval information is received from the FTCI 700, the relay server 300 notifies with the settlement non-approval information to the mobile communication terminal 200 and the home shopping system 600. In this exemplary embodiment, the relay server 300 notifies with the settlement non-approval information to the mobile communication terminal 200 and the home shopping system 600, respectively. Alternatively, the relay server 300 notifies with the settlement non-approval information to one of the mobile communication terminal 200 and the home shopping system 600. Further alternatively, the relay server 300 does not notify the settlement non-approval information to the mobile communication terminal 200 and the home shopping system 600.

In step S416, when it is checked that the settlement approval information is received from the FTCI 700, the relay server 300 transmits a settlement approval SMS message to the mobile communication terminal 200 (step S422). Accordingly, the settlement approval SMS message is displayed on the mobile communication terminal 200 (step S424).

Then, the relay server 300 transmits the settlement approval information to the home shopping system 600 (step S426). Thus, the home shopping system 600 transmits an online receipt according to the settlement approval information to the mobile communication terminal 200 (step S428), and the mobile communication terminal 200 receives the online receipt (step S430). In this exemplary embodiment, the online receipt is transmitted to the mobile communication terminal 200. Alternatively, the online receipt may be transmitted to an additional e-mail account of the customer possessing the mobile communication terminal 200.

As described above, according to an exemplary embodiment of the present invention, a settlement is performed through an FTCI and the CMS system in accordance with a result of credit inquiry of an account of the customer not a settlement manner through a credit card system, so that it is not necessary to issue the credit card. Thus, issuing a credit card may be omitted, so that expenses for issuing a credit card and human labor for delivering the credit card to user may be reduced. Moreover, settlement is performed through the FTCI, so that it may be easy to observe transaction details of a customer and total sales of each shop. Consequently, the national tax service may impose a duty based on the total sales, so that an omission of the tax may be prevented.

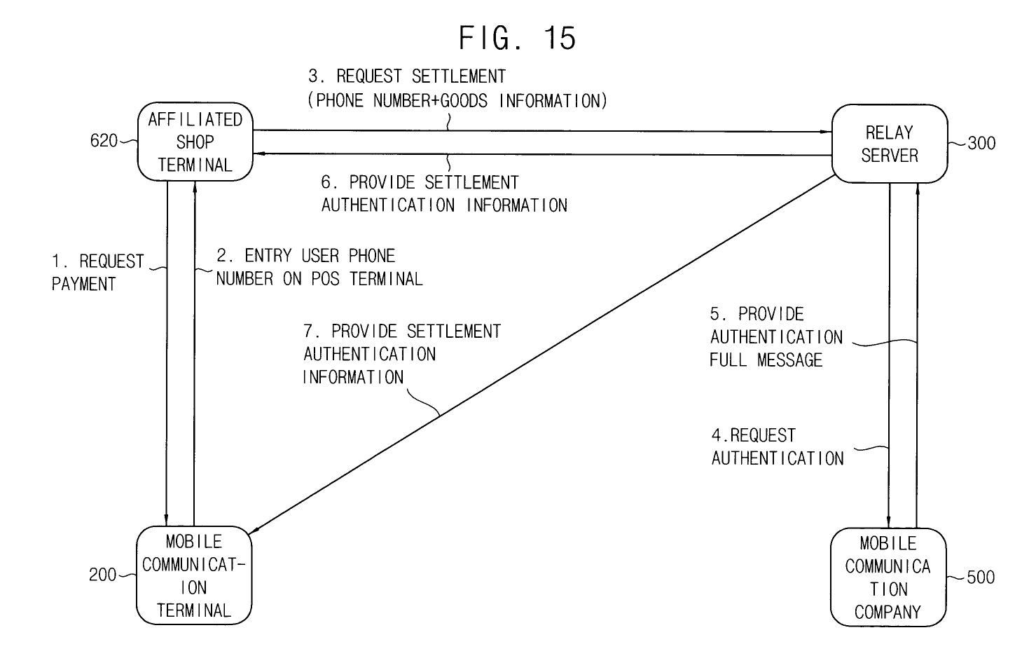

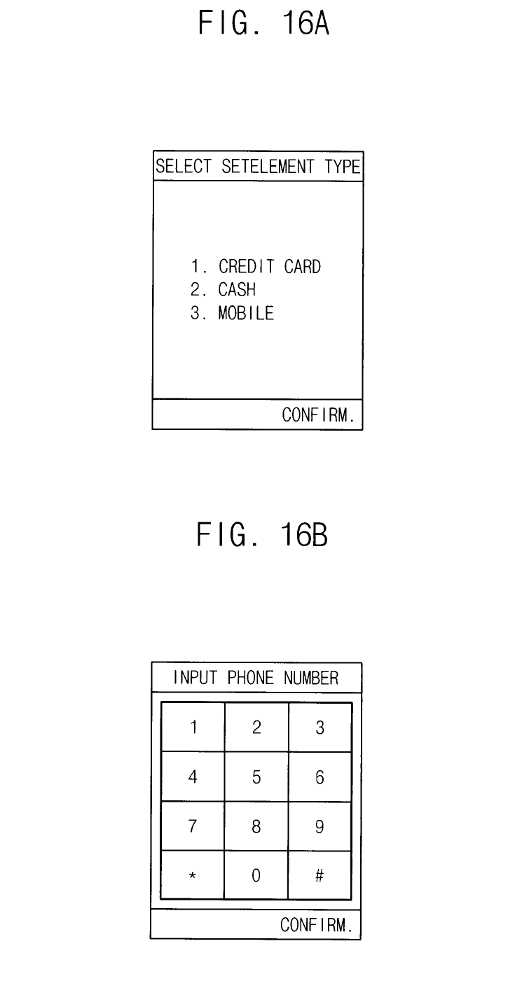

FIG. 15 is a conceptual diagram illustrating a settlement relay system according to still another exemplary embodiment of the present invention. FIGS. 16A, 16B and 16C are images showing examples of a display screen of a POS terminal or a mobile communication terminal at a settlement relay system described in FIG. 15.

Referring to FIG. 15, a settlement system according to still another exemplary embodiment may be explained by an affiliated shop terminal (hereinafter, an affiliated shop terminal) 620, a mobile communication terminal 200, a relay server 300 and a mobile communication company system 500.

The affiliated shop terminal 620 or clerk requests a settlement to a customer possessing the mobile communication terminal 200. For example, as shown in FIG. 16A, the affiliated shop terminal 620 requests a selection of a settlement method through a display screen thereof. For example, the affiliated shop terminal 620 may perform a process corresponding to a credit card settlement when the customer selects a button <1>, the affiliated shop terminal 620 may perform a process corresponding to a cash settlement when the customer selects a button <2>, and the affiliated shop terminal 620 may perform a process corresponding to a mobile settlement when the customer selects a button <3>.

Thus, when the customer clicks a button <3>, the affiliated shop terminal 620 may display a screen as shown in FIG. 16B. For example, the affiliated shop terminal 620 may display a screen for receiving a phone number of the customer. When the customer inputs the phone number through the affiliated shop terminal 620, the affiliated shop terminal 620 requests a settlement by providing the relay server 300 with the phone number, an affiliated shop number or an affiliated shop code, a transaction amount, etc. Accordingly, the customer does not need to provide unauthorized people with his/her own credit card so as to settle a bill, so that risk of loss or risk of duplication of a corresponding credit card may be prevented.

The relay server 300 requests an authentication corresponding to a settlement of a corresponding transaction to the communication company system 500 corresponding to the phone number data, based on the phone number provided from the affiliated shop terminal 620.

The communication company system 500 provides the relay server 300 with an authentication full message data corresponding to a settlement of a corresponding transaction.

As the authentication full message data is provided from the communication company system 500, the relay server 300 provides the affiliated shop terminal 620 with settlement approval information for notifying that a corresponding transaction is normally completed. In addition, the relay server 300 may further provide the mobile communication terminal 200 with the settlement approval information for notifying that a corresponding transaction is normally completed.

In this exemplary embodiment, the relay server 300 provides the affiliated shop terminal 620 and the mobile communication terminal 200 with the settlement approval information. In addition, the communication company system 500 may further provide the affiliated shop terminal 620 and the mobile communication terminal 200 with the settlement approval information. In this case, the relay server 300 may not provide the affiliated shop terminal 620 and the mobile communication terminal 200 with the settlement approval information.

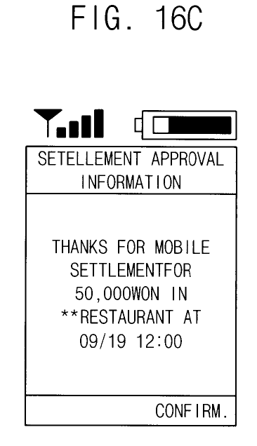

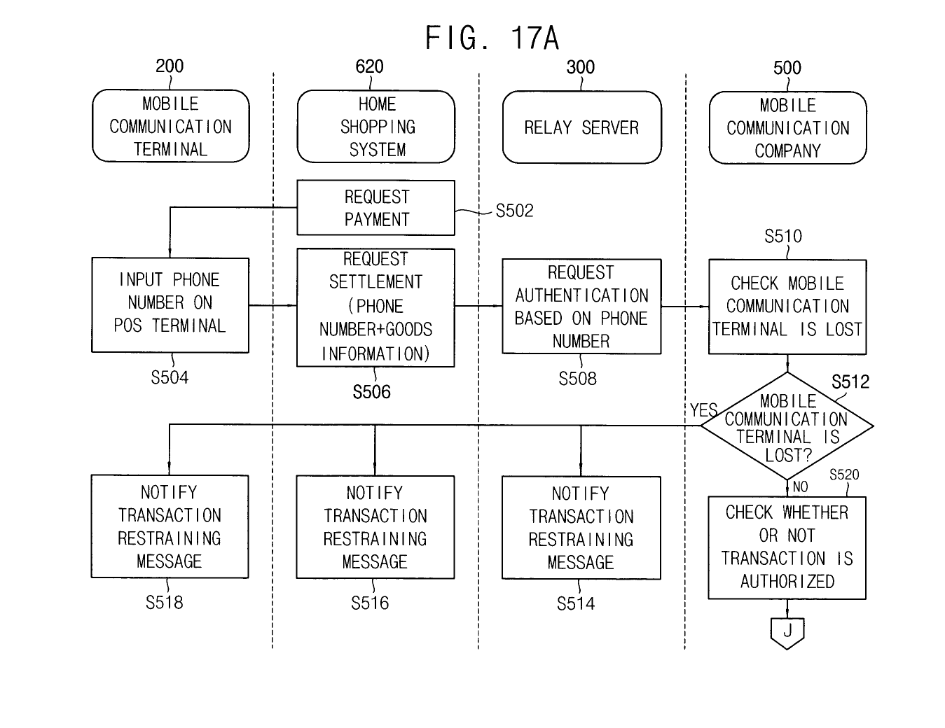

FIGS. 17A and 17B are flowcharts showing a settlement relay scenario described in FIG. 15.

Referring to FIGS. 15, 17A and 17B, as a clerk or a manager of an affiliated shop in which the affiliated shop terminal 620 is established requests a settlement to a customer possessing the mobile communication terminal 200 (step S502), the customer inputs a phone number on the affiliated shop terminal 620 such as a POS terminal (step S504). Accordingly, the customer does not need to provide unauthorized people with his/her own credit card so as to settle a bill, so that risk of loss or risk of duplication of a corresponding credit card may be prevented.

Then, the affiliated shop terminal 620 requests a settlement to the relay server 300 (step S506). The request of the settlement may be realized through a phone number data inputted by the customer, goods information, etc. When the affiliated shop is a restaurant, the goods information may include, for example, a particle number of the restaurant, a table number, a food number, price information for the food, etc.

Then, the relay server 300 requests an authentication to the mobile communication company 300, based on the phone number included in settlement request information provided from the affiliated shop terminal 620 (step S508).

Then, the mobile communication company system 500 receiving a request of an authentication confirms whether the mobile communication terminal 200 is lost or not based on the phone number (step S510), and checks whether the mobile communication terminal 200 is lost or not (step S512). In the step S512, when it is checked that the mobile communication terminal 200 is lost, the mobile communication company system 500 may notify with a transaction restraining message to the relay server 300 (step S514). Moreover, when it is checked that the mobile communication terminal 200 is lost, the mobile communication company system 500 may notify with the transaction restraining message to the affiliated shop terminal 620 (step S516). Furthermore, when it is checked that the mobile communication terminal 200 is lost, the mobile communication company system 500 may notify with the transaction restraining message to the mobile communication terminal 200 (step S518). In this exemplary embodiment, when it is checked that the mobile communication terminal 200 is lost, the mobile communication company system 500 transmits the transaction restraining message to the relay server 300, the affiliated shop terminal 620 and the mobile communication terminal 200. Alternatively, when it is checked that the mobile communication terminal 200 is lost, the mobile communication company system 500 may only transmit the transaction restraining message to the relay server 300.

In the step S512, when it is checked that the mobile communication terminal 200 is not lost, the mobile communication company system 500 inquires whether a corresponding transaction is authorized or not (step S520). For example, the mobile communication company system 500 may inquire a credit status such as a credit of a subscriber corresponding to the phone number date based on a corresponding phone number data to inquire whether the corresponding transaction is authorized or not. Then, the mobile communication company system 500 checks whether the corresponding transaction is authorized or not (step S522). When it is checked that the corresponding transaction is not authorized in the step S522, the mobile communication company system 500 may notify that a corresponding transaction is not authorized to the relay server 300 (step S524). Accordingly, when a notification that a corresponding transaction is not authorized is received from the mobile communication company system 500, the relay server 300 transmits the notification that a corresponding transaction is not authorized to the affiliated shop terminal 620 (step S526). Moreover, the relay server 300 transmits the notification that a corresponding transaction is not authorized to the mobile communication terminal 200 (step S528).

In the step S522, when it is checked the corresponding transaction is authorized, the mobile communication company system 500 may notify that the corresponding transaction is authorized to the relay server 300 (step S530). Accordingly, when a notification that a corresponding transaction is authorized is received from the mobile communication company system 500, the relay server 300 transmits the notification that a corresponding transaction is authorized to the affiliated shop terminal 620 (step S532). Moreover, the relay server 300 may transmit the notification that the corresponding transaction is authorized to the mobile communication terminal 200 (step S534).

The relay server 300 performing a process corresponding to the step S530 stores settlement information corresponding to a corresponding phone number data (step S536). Since the settlement information corresponding to the phone number data is stored, the relay server 300 may periodically ask the mobile communication company system 500 in correspondence with the phone number data to settle a bill.

As described above, according to an exemplary embodiment of the present invention, a settlement is performed by inputting a mobile communication terminal number (or a phone number) of a customer not a settlement manner through a credit card system, so that it is not necessary to issue a credit card. Thus, issuing a credit card may be omitted, so that expenses for issuing a credit card and human labor for delivering the credit card to user may be reduced. Moreover, a settlement is performed through the FTCI, so that it may be easy to observe transaction details of a customer and total sales of each shop. Consequently, the national tax service may impose a duty based on the total sales, so that an omission of the tax may be prevented.

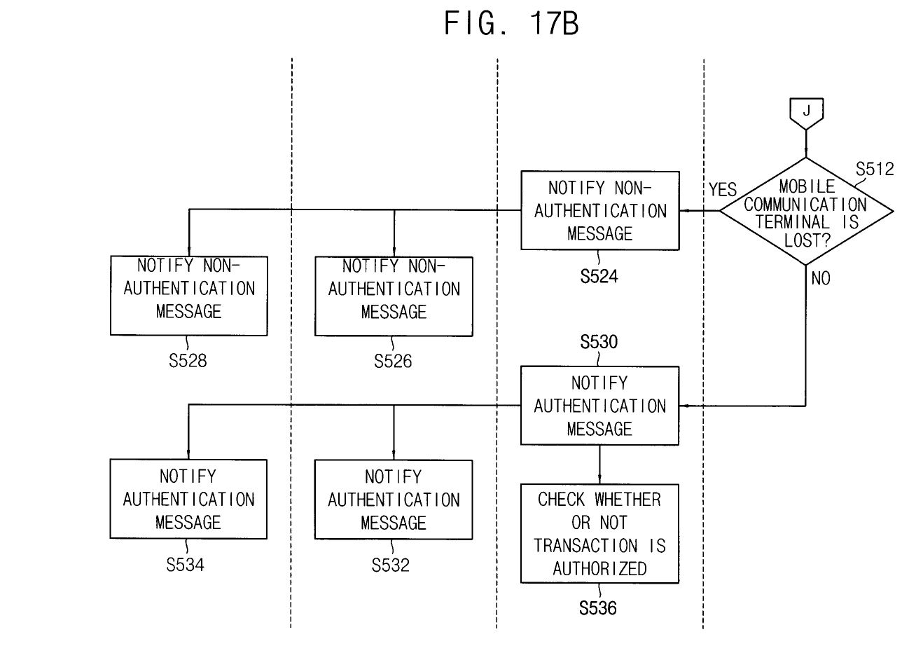

FIG. 18 is a conceptual diagram illustrating a settlement relay system according to still another exemplary embodiment of the present invention.

Referring to FIG. 18, a settlement system according to still another exemplary embodiment may be explained by an affiliated shop terminal 640, a mobile communication terminal 200, a relay server 300 and a mobile communication company system 500.

The affiliated shop terminal 640 may print a receipt in a piece of paper to deliver the receipt to a customer possessing the mobile communication terminal 200. Alternatively, the affiliated shop terminal 640 may generate an electronic receipt to transmit the electronic receipt to the mobile communication terminal 200.

When the paper receipt is delivered, the user may enter goods information that is printed on the receipt in the mobile communication terminal 200 to transmit the goods information to the relay server 300. Alternatively, when the electronic receipt is received from the affiliated shop terminal 640, the mobile communication terminal 200 may transmit the goods information corresponding to the receipt to the relay server 300. In this exemplary embodiment, the goods information may include an affiliated shop code, a service code (i.e., a table number), a requesting date, etc. When the goods information is included as a packet including a plurality of bits, the affiliated shop code may be positioned at a side of a most significant bit (MSB), and the requesting date may be positioned at a side of a least significant bit (LSB).

The relay server 300 requests an authentication of a corresponding transaction to the mobile communication company 500 based on a phone number date and goods information that are provided from the mobile communication terminal 200.

As an authentication is requested from the relay server 300, the mobile communication company 500 inquires whether the phone number is authorized or not by inquiring information corresponding to the phone number, and transmits an authentication full message data corresponding to the result of the inquiry to the relay server 300.

The relay server 300 which receives the authentication full message data may transmit settlement approval information to the affiliated shop terminal 640. In addition, the relay server 300 may further transmit the settlement approval information to the mobile communication terminal 200.

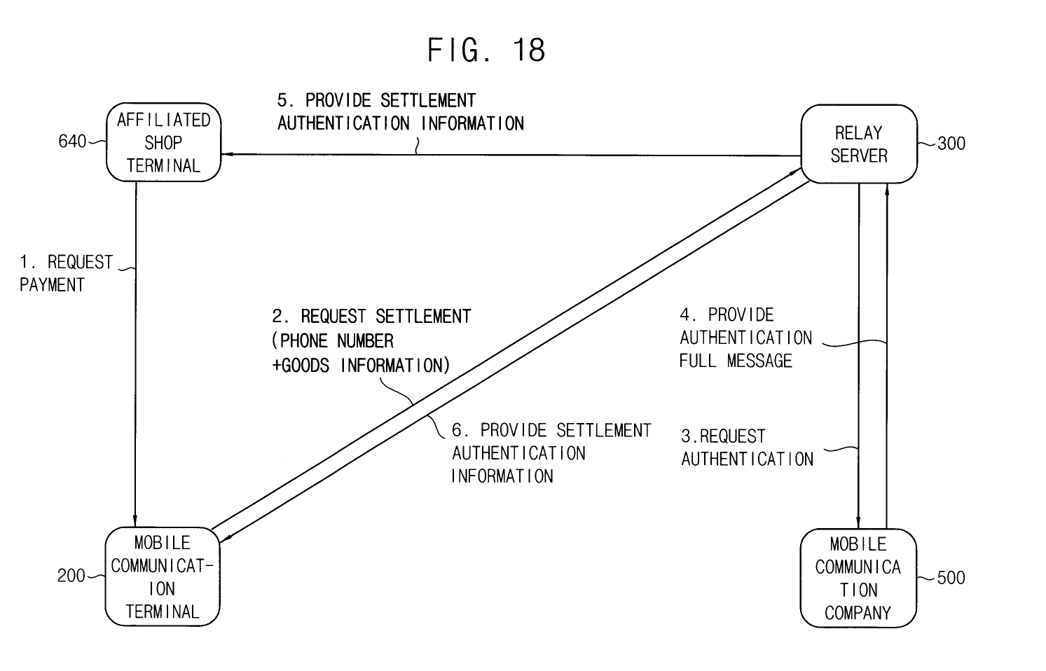

FIGS. 19A and 19B are flowcharts showing a settlement relay method described in FIG. 18.

Referring to FIGS. 19A and 19B, as a clerk or a manager of an affiliated shop in which the affiliated shop terminal 640 is established requests a settlement to a customer possessing the mobile communication terminal 200 (step S602), the customer opens a page for a mobile settlement through the mobile communication terminal 200 (step S604), and then requests a settlement to the relay server by inputting good information on the page for the mobile settlement (step S606). The request of the settlement may be realized through the goods information inputted by the customer. When the affiliated shop is a restaurant, the goods information may include, for example, a particle number of the restaurant, a table number, a food number, price information for the food, etc.

Then, the relay server 300 requests an authentication to the mobile communication company 300, based on the phone number included in a settlement request information provided from the affiliated shop terminal 640 (step S608).

Then, the mobile communication company system 500 receiving a request of an authentication confirms whether the mobile communication terminal 200 is lost or not based on the phone number (step S610), and checks whether the mobile communication terminal 200 is lost or not (step S612). In the step S612, when it is checked that the mobile communication terminal 200 is lost, the mobile communication company system 500 may notify with a transaction restraining message to the relay server 300 (step S614). Moreover, when it is checked that the mobile communication terminal 200 is lost, the mobile communication company system 500 may notify with the transaction restraining message to the affiliated shop terminal 640 (step S616). Furthermore, when it is checked that the mobile communication terminal 200 is lost, the mobile communication company system 500 may notify with the transaction restraining message to the mobile communication terminal 200 (step S618). In this exemplary embodiment, when it is checked that the mobile communication terminal 200 is lost, the mobile communication company system 500 transmits the transaction restraining message to the relay server 300, the affiliated shop terminal and the mobile communication terminal 200. Alternatively, when it is checked that the mobile communication terminal 200 is lost, the mobile communication company system 500 may only transmit the transaction restraining message to the relay server 300.

In the step S612, when it is checked that the mobile communication terminal 200 is not lost, the mobile communication company system 500 inquires whether a corresponding transaction is authorized or not (step S620). For example, the mobile communication company system 500 may inquire a credit status such as a credit of a subscriber corresponding to the phone number date based on a corresponding phone number data to inquire whether the corresponding transaction is authorized or not. Then, the mobile communication company system 500 checks whether the corresponding transaction is authorized or not (step S622). When it is checked that the corresponding transaction is not authorized in the step S622, the mobile communication company system 500 may notify that a corresponding transaction is not authorized to the relay server 300 (step S624). Accordingly, when a notification that a corresponding transaction is not authorized is received from the mobile communication company system 500, the relay server 300 transmits the notification that a corresponding transaction is not authorized to the affiliated shop terminal 640 (step S626). Moreover, the relay server 300 transmits the notification that a corresponding transaction is not authorized to the mobile communication terminal 200 (step S628).

In the step S622, when it is checked the corresponding transaction is authorized, the mobile communication company system 500 may notify that the corresponding transaction is authorized to the relay server 300 (step S630). Accordingly, when a notification that a corresponding transaction is authorized is received from the mobile communication company system 500, the relay server 300 transmits the notification that a corresponding transaction is authorized to the affiliated shop terminal 640 (step S632). Moreover, the relay server 300 may transmit the notification that the corresponding transaction is authorized to the mobile communication terminal 200 (step S634).

The relay server 300 performing a process corresponding to the step S630 stores settlement information corresponding to a corresponding phone number data (step S636). Since the settlement information corresponding to the phone number data is stored, the relay server 300 may periodically ask the mobile communication company system 500 in correspondence with the phone number data to settle a bill.

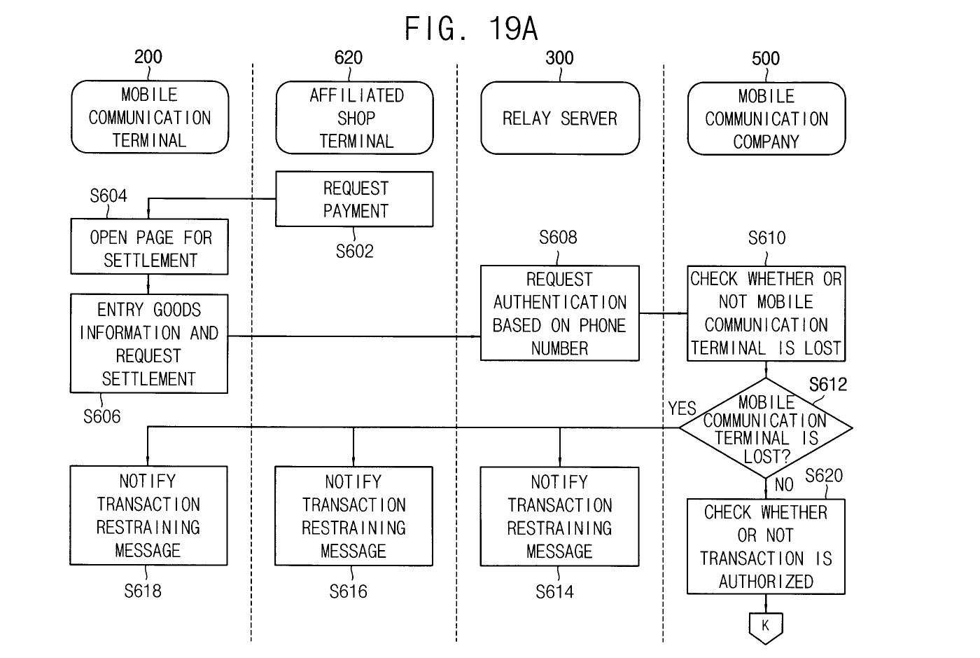

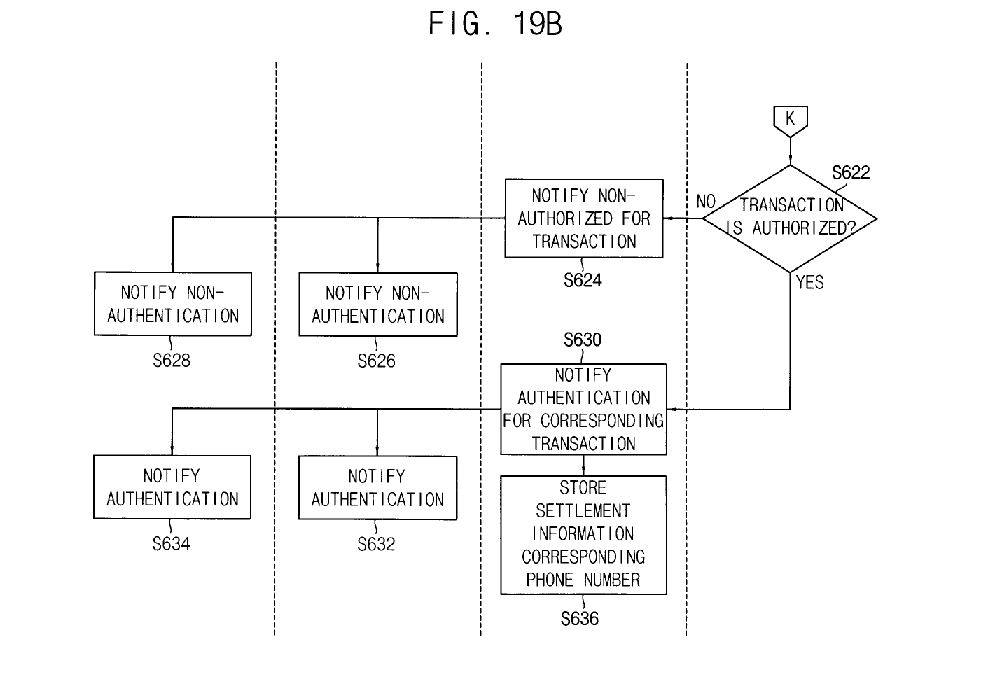

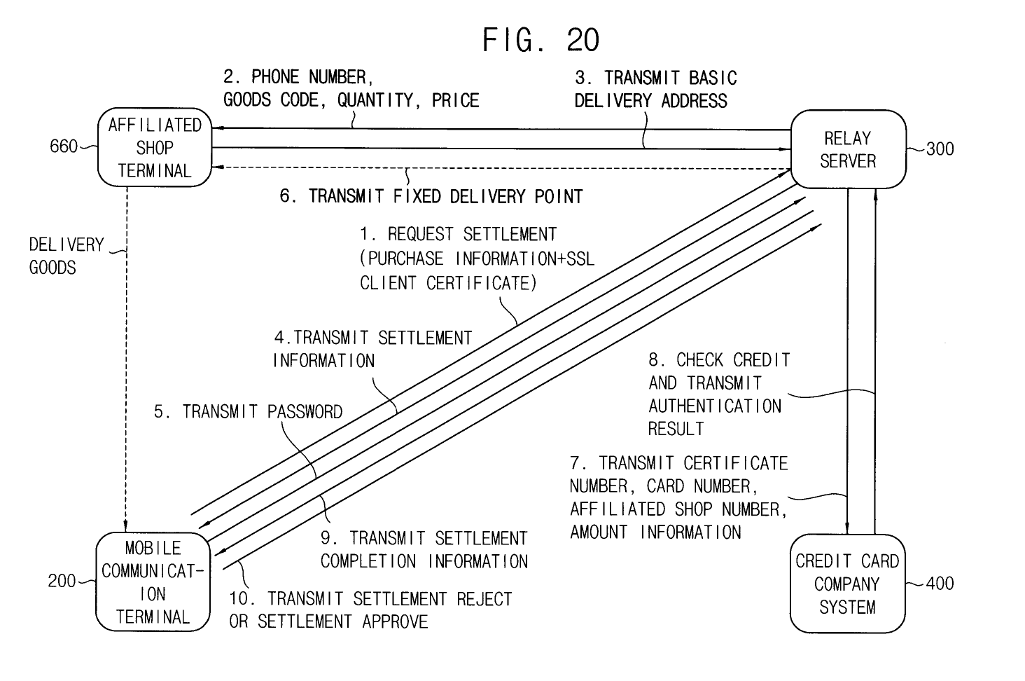

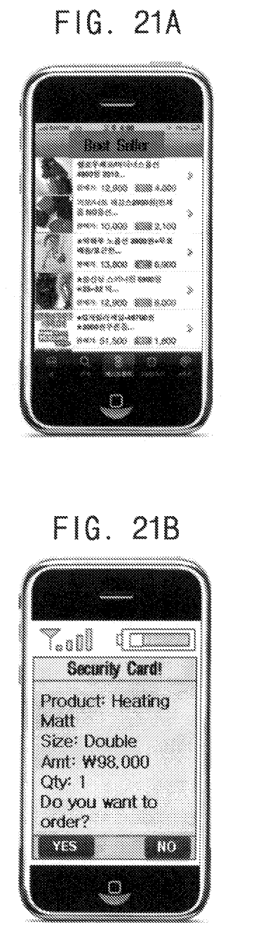

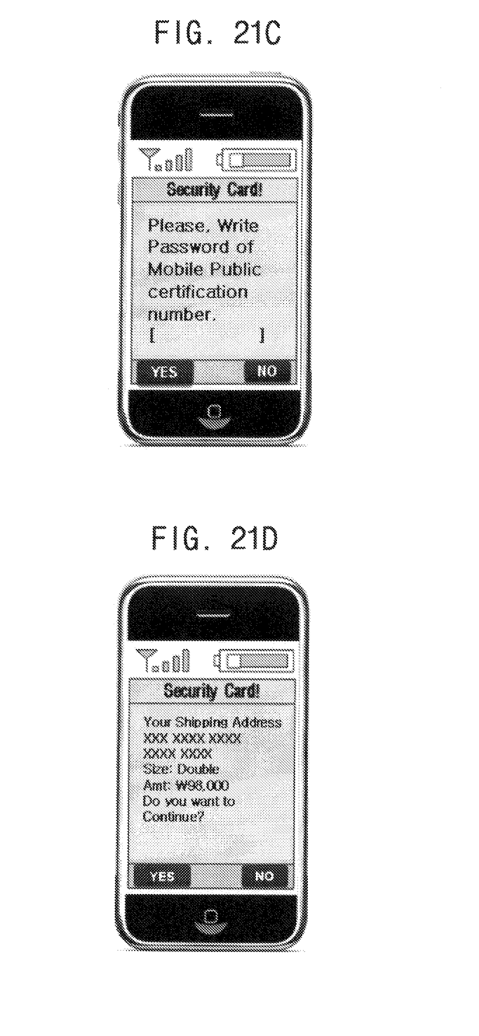

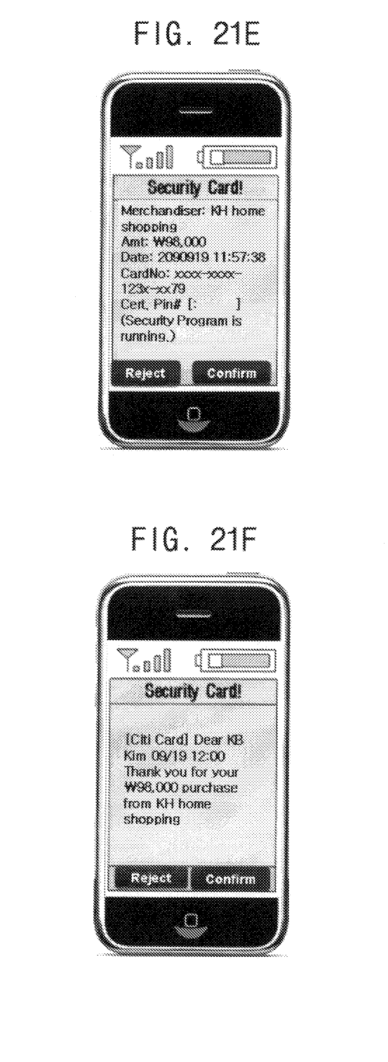

FIG. 20 is a conceptual diagram illustrating a settlement relay system according to still another exemplary embodiment of the present invention. FIGS. 21A, 21B, 21C, 21D, 21E and 21F are images showing examples of a display screen of a mobile communication terminal.

Referring to FIG. 20, a settlement system according to still another exemplary embodiment may be explained by a mobile communication terminal 200, a relay server 300, a credit card company system 400 and an affiliated shop terminal 660.

The mobile communication terminal 200 requests a settlement by transmitting purchase information (or a purchase request data) and a mobile SSL client certificate to the relay server 300 in accordance with an operation of a user. In the present exemplary embodiment, the purchase request data may include goods code data, a quantity data of the goods, a price per unit data (or amount data), etc. Moreover, in the present exemplary embodiment, the mobile SSL client certificate may include an SSL client certificate and a credit card number that are encoded therein.

The mobile SSL client certificate may be generated by encoding an SSL client certificate and a credit card number through an encoding program provided from the relay server 300. The mobile SSL client certificate may include at least one credit card number. In addition, the mobile-SSL client certificate may further include not only a credit card number encoded in the SSL client certificate but also a phone number data of the mobile communication terminal 200.

For example, as shown in FIG. 21A, when the user wants to purchase predetermined goods by accessing an affiliated shop or an online page of the corresponding affiliated shop in accordance with an operation of the user, a screen shown in FIG. 21B may be displayed on the mobile communication terminal 200.

Referring to FIG. 21B, a purchase information selected by the user is displayed on a screen window of the mobile communication terminal 200. In this exemplary embodiment, the goods data is a heating mat, a size of the heating mat is a double, a price per unit of the heating mat is 98,000 Korean won (about $95 in US dollar), and a purchase quantity is one. When the user selects corresponding purchase information, as shown in FIG. 21C, a screen requesting an inputting of a password of the mobile SSL client certificate may be displayed thereon. When the password of the mobile SSL client certificate is inputted by the user, the mobile communication terminal may compare a password allowed when the mobile SSL client certificate is generated and the password inputted by the user. When it is checked that the password stored in the mobile communication terminal 200 and the password inputted by the user are matched with each other, the mobile communication terminal 200 transmits the mobile-SSL client certificate and the purchase information to the relay server 300.

The relay server 300 may decode the mobile-SSL client certificate provided from the mobile communication terminal 200 to obtain an SSL client certificate, and may check whether the corresponding mobile communication terminal 200 is authorized or not, based on the SSL client certificate. Since a program generating the mobile-SSL client certificate by encoding a credit card number in the SSL client certificate may be provided from the relay server 300, the relay server 300 may sufficiently decode the mobile-SSL client certificate to obtain the SSL client certificate and the credit card number.

When it is checked that the corresponding mobile communication terminal 200 is authorized, the relay server system 300 may transmit a phone number data, a goods code data, a goods quantity data and a price data to the affiliated shop terminal 660.

The affiliated shop terminal 660 confirms affiliated shop information based on the phone number, and then transmits a main delivery address corresponding to the affiliated shop information to the relay server 300. In this exemplary embodiment, the affiliated shop terminal 660 may be a home shopping system, an internet shopping mall, an automated response system (ARS) shopping network, a television (TV) home shopping network, an online shopping network, etc. Alternatively, the affiliated shop terminal 660 may be systems managed at an offline market, a restaurant, a gas station, etc. In this case, a process receiving a main delivery address from the affiliated shop terminal 660 to the relay server 300 may be omitted.

The relay server 300 transmits main delivery address and settlement information to the mobile communication terminal 200. Thus, the mobile communication terminal 200 may display a screen as shown in FIG. 21D.

A user of the mobile communication terminal 200 confirms the main delivery address and the settlement information through a screen as shown in FIG. 21D, and then clicks or touches a yes button when the customer agrees with a corresponding purchase matter. Thus, a screen such as FIG. 21E is displayed on a display window of the mobile communication terminal 200.

As shown in FIG. 21E, a user confirms seller information of a goods data, price information, settlement time information, a credit card number, etc., and again enters a password to request a final confirmation of a corresponding purchase by clicking or touching a “CONFIRM” button. Although not shown in FIG. 21E, when the user wants to receive the goods through another delivery address not a main delivery address set by the user, the mobile communication terminal 200 may further display an additional input window for inputting another delivery address if the user clicks or touches a “NO” button. The user may change the delivery address by inputting another delivery address on the display window of the mobile communication terminal 200. The change of the delivery address may be effectively utilized to send a gift to other people after purchasing the goods at an internet shopping mall, etc.

When another delivery address is received from the mobile communication terminal 200, the relay server 300 transmits a fixed delivery address corresponding to another delivery address to the affiliated shop terminal 660. From now on, a manager of the affiliated shop terminal 660 may deliver goods to the user of the mobile communication terminal 200 based on the fixed delivery address information, and may ask the credit card company system 400 or the relay server 300 to pay for a purchase according to a corresponding transaction.

Then, the relay server 300 obtaining the final confirmation of a corresponding transaction from the mobile communication terminal 200 may relay a settlement by transmitting an SSL client certificate number, a card number, an affiliated shop number and price information to the credit card company system 400. When one credit card number is encoded in a mobile SSL client certificate, the relay server 300 may relay a settlement between the mobile communication terminal 200 and the credit card company system 400 based on a decoded credit card number. When plural credit card numbers are encoded in a mobile SSL client certificate, the relay server 300 may transmit a question that which credit card should be used for a settlement to the mobile communication terminal 200. As a predetermined credit card is selected by a corresponding mobile communication terminal as a response for the question, the relay server 300 may relay a settlement between the mobile communication terminal 200 and the credit card company system 400 based on a decoded credit card number corresponding to the selected credit card.

The credit card company system 400 confirms a credit status of a customer possessing the mobile communication terminal 200 based on an SSL client certificate number, a card number, an affiliated shop number and price information that are transmitted from the relay server 300, and transmits result information for an authentication confirmation to the relay server 300. The credit card company system 400 may further confirm whether a corresponding credit card is lost or not.

When result information for an authentication confirmation is provided from the credit card company system, the relay server 300 transmits settlement completion information to the mobile communication terminal 200. Accordingly, a display window of the mobile communication terminal 200 may display a final confirmation and appreciation message according to a corresponding goods purchase as shown in FIG. 21F.

When the user clicks or touches a “CONFIRM” button for the corresponding purchase on the display window as shown in FIG. 21F, a settlement relay process according to the corresponding purchase may be ended. However, when the user wants to withdraw from the corresponding purchase, the user may request a withdrawal of the corresponding goods purchase by clicking or touching a “REJECT” button as shown in FIG. 21F. When the request for the withdrawal of the corresponding goods purchase is received, the relay server 300 may request a withdrawal of the corresponding goods purchase to the credit card company system 400 and the affiliated shop terminal 660.

In the present exemplary embodiment, the relay server 300 may be realized by a communication part (not shown) and a system control part (not shown). The communication part is connected to the affiliated shop terminal 660, the mobile communication terminal 200 and the credit card company system 400 through a communication network.

The system control part may be designed to receive a purchase request data and a mobile SSL client certificate in which an SSL client certificate and a credit card number are encoded from the mobile communication terminal 200 through the communication module. The system control part may be designed to transmit a phone number data, goods code data, purchase quantity data and price data of a purchase to an affiliated shop terminal 660 corresponding to the purchase request data when it is checked that a mobile communication terminal is authorized based on an SSL client certificate that is obtained from the mobile SSL client certificate. The system control part may be designed to relay a settlement by transmitting an SSL certificate number, a card number, an affiliated shop terminal number and price information to a corresponding credit card company system 400 based on a credit card number that is encoded in the mobile-SSL client certificate. The system control part may be designed to check a credit status of a customer corresponding to the mobile communication terminal by the credit card company system 400 and then to transmit settlement completion information to the mobile communication terminal 200.

The relay server 300 according to the present embodiment may be realized by a configuration of various hardware components. For example, the relay server 300 may be realized in a similar manner such as a configuration described in FIG. 2. Thus, any repetitive detailed description thereof will hereinafter be omitted.

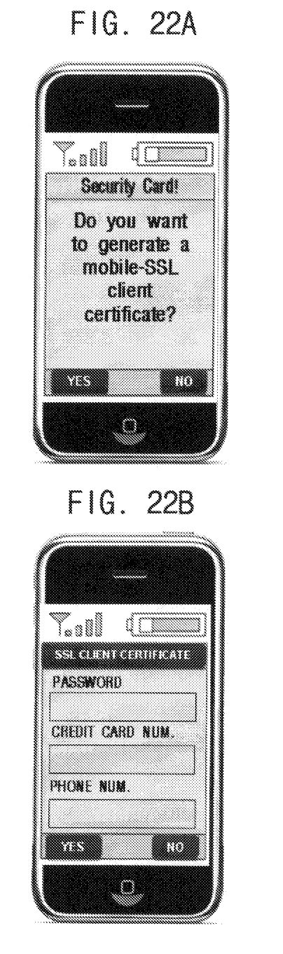

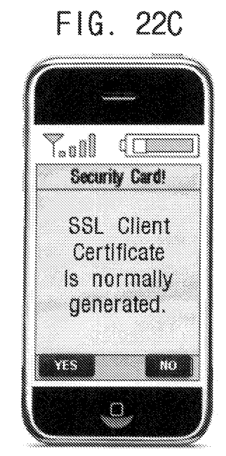

FIGS. 22A, 22B and 22C are images showing examples of a display screen of a mobile communication terminal for explaining operations generating a mobile-SSL client certificate explained in FIGS. 20 to 21F.

Firstly, in order to generate a mobile SSL client certificate, an SSL client certificate stored in a user's own computer is stored in a mobile communication terminal in response to an operation of the user. Moreover, a program generating a mobile SSL client certificate which is uploaded in an internet web page is downloaded in the mobile communication terminal to install the program therein. The program may be downloaded through a connection with a computer, and may be downloaded through a wireless internet or a wireless mobile network (or a wireless mobile communication network). Then, the downed program is installed to generate a mobile SSL client certificate by driving a corresponding program. For example, when the user clicks or touches a button for generating a mobile SSL client certificate through a selection of a menu screen of a corresponding mobile communication terminal, a selection of an icon, etc., a screen as shown in FIG. 22A may be displayed. Referring to FIG. 22A, the screen may display a message of <Do you want to generate a mobile SSL client certificate?>.

Then, for example, when the user clicks or touches a “YES” button, a screen as shown in FIG. 22B may be displayed. Referring to FIG. 22B, in order to generate the mobile SSL client certificate, a window for inputting a password, a window for inputting a credit card number and a window for inputting a phone number may be displayed.

In this exemplary embodiment, plural credit card numbers may be inputted. For one example, the credit card numbers may be manually inputted into the mobile communication terminal. For another example, the credit card numbers may be obtained from information stored in a USIM card embedded in the mobile communication terminal. When the user selects one credit card number to click or touch a “CONFIRM’ button, the selected credit card number and an SSL client certificate may be encoded to generate a mobile SSL client certificate.

The mobile SSL client certificate may be generated at an every event corresponding to goods purchase. In this case, one credit card number may be encoded in accordance with one SSL client certificate to be generated as the mobile SSL client certificate.

Alternatively, the mobile-SSL client certificate may be generated for an initial use when a user purchases the mobile communication terminal. Further alternatively, the mobile SSL client certificate may be generated in accordance with a selection of a user. In this case, plural credit card numbers may be encoded in accordance with one SSL client certificate to be generated as the mobile SSL client certificate.

In an offline affiliated shop such as an offline market, a restaurant, a gas station, etc., a settlement system such as a POS terminal processing a settlement through a conventional credit card is installed. In order to utilize a settlement relay system according to the present invention, the settlement system downloads an additional program which identifies an affiliated shop identification code, a purchase amount, an item of goods, a purchase quantity, etc., from the relay server, and then installs the additional program. Thus, a settlement relay method according to exemplary embodiments of the present invention may be adapted by installing the additional program into a convention settlement system such as a POS terminal without a construction of an additional system, so that a manager of the affiliated shop may secure many customers without facing a high expense.

As described above, according to the present invention, a customer who wants to purchase goods generates a mobile SSL client certificate through his/her own mobile communication terminal, and then the user performs a settlement to request a purchase of the goods to a relay server by transmitting the mobile SSL client certificate. Therefore, a credit card number is not transmitted to an affiliated shop terminal, so that risk of loss or risk of duplication of a corresponding credit card may be prevented.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A settlement relay method by using a relay server connected to an affiliated shop terminal, a mobile communication terminal of a customer and a credit card company system, the method comprising:
receiving a settlement serial number data corresponding to a settlement from the mobile communication terminal via a communication network;
receiving a receipt serial number data from the affiliated shop terminal via a communication network; and
performing a procedure corresponding to a transaction approval, when it is checked that the settlement serial number data and the receipt serial number data are matched with each other.

2. The settlement relay method of claim 1, wherein performing the procedure corresponding to the transaction approval comprises:
requesting a credit card number data to the mobile communication terminal;
receiving an authentication response full message data from the credit card company system, the authentication response full message data being generated by confirming the credit card number data by the credit card company system after the credit card number data is inputted to the credit card company system through the mobile communication terminal;
requesting a settlement authentication to a corresponding credit card company system, when the authentication response full message data is authorized; and
transmitting an authentication response to the affiliated shop terminal, when the authentication response is received from the credit card company system.

3. The settlement relay method of claim 2, further comprising:
transmitting the authentication response to the mobile communication terminal, when the authentication response is received from the credit card company system.

4. The settlement relay method of claim 2, wherein performing the procedure corresponding to the transaction approval further comprises:
inquiring whether a corresponding mobile communication terminal is lost or not to a mobile communication company system, when it is checked that the settlement serial number data and the receipt serial number data are matched with each other.

5. The settlement relay method of claim 1, wherein the receipt serial number data includes an inherent number of an affiliated shop, a number corresponding to goods data, and transaction amount information, and the settlement serial number data includes an inherent number of an affiliated shop, a number corresponding to goods data, and transaction amount information.

6. The settlement relay method of claim 5, wherein the settlement serial number data is printed on a receipt in a bar code type or a quick response (QR) code type, and the settlement serial number printed in bar code type or the QR code type is scanned by the mobile communication terminal.

7. The settlement relay method of claim 1, wherein performing the procedure corresponding to the transaction approval comprises:
providing an affiliated shop name and transaction amount to the corresponding mobile communication terminal to request a credit card number data;
receiving a bank identification number (“BIN”) of a credit card and a purchase amount from the corresponding mobile communication terminal;
checking whether a corresponding transaction is a No Authentication Required transaction or not based on the BIN of a credit card and the purchase amount;
providing a transaction success message according to the No Authentication Required transaction to the affiliated shop terminal when it is checked that the corresponding transaction is the No Authentication Required transaction; and
providing a transaction restraining message according to the No Authentication Required transaction to the affiliated shop terminal when it is checked that the corresponding transaction is not the No Authentication Required transaction.

8. The settlement relay method of claim 7, further comprising:
providing a transaction restraining message according to the No Authentication Required transaction to the mobile communication terminal when it is checked that the corresponding transaction is not the No Authentication Required transaction.

9. A settlement relay system, which is connected to an affiliated shop terminal, a mobile communication terminal of a customer and a credit card company system, comprising:
a communication part connected to the affiliated shop terminal and the mobile communication terminal through a communication network; and
a system control part (i) receiving a settlement serial number data corresponding to a settlement from the mobile communication terminal via a communication network, (ii) receiving a receipt serial number data from the affiliated shop terminal via a communication network, and (iii) performing a procedure corresponding to a transaction approval, when it is checked that the settlement serial number data and the receipt serial number data are matched with each other.

10. The settlement relay system of claim 9, wherein the system control part requests a credit card number data to the mobile communication terminal, so as to perform the procedure corresponding to the transaction approval,
receives an authentication response full message data from the credit card company system, wherein the authentication response full message data is generated by confirming the credit card number data by the credit card company system after the credit card number data is inputted to the credit card company system through the mobile communication terminal,
requests a settlement authentication to a corresponding credit card company system, when the authentication response full message data is authorized, and
transmits an authentication response to the affiliated shop terminal, when the authentication response is received from the credit card company system.

11. The settlement relay system of claim 9, wherein the system control part inquires whether a corresponding mobile communication terminal is lost or not to a mobile communication company system, when it is checked that the settlement serial number data and the receipt serial number data are matched with each other, so as to perform the procedure corresponding to the transaction approval.

12. The settlement relay system of claim 9, wherein the system control part provides an affiliated shop name and a transaction amount to the corresponding mobile communication terminal to request a credit card number data, so as to perform the procedure corresponding to the transaction approval,
receives a bank identification number (“BIN”) of a credit card and a purchase amount from the corresponding mobile communication terminal,
checks whether a corresponding transaction is a No Authentication Required transaction or not based on the BIN of a credit card and the purchase amount,
provides a transaction success message according to the No Authentication Required transaction to the affiliated shop terminal when it is checked that the corresponding transaction is the No Authentication Required transaction, and
provides a transaction restraining message according to the No Authentication Required transaction to the affiliated shop terminal when it is checked that the corresponding transaction is not the No Authentication Required transaction.

13. The settlement relay system of claim 9, wherein the system control part comprises:
a small sum settlement control module controlling a process corresponding to a small sum settlement;
an authentication control module controlling a process corresponding to an authentication; and
a serial number control module confirming whether the settlement serial number data and the receipt serial number data are matched with each other or not.

14. The settlement relay system of claim 9, wherein the communication part comprises:
an affiliated shop terminal communication module connected to the affiliated shop terminal through communication networks;
a mobile communication module connected to the mobile communication company system through a communication network; and
a bank company communication module connected to the bank company system through a communication network.

15. The settlement relay system of claim 9, further comprising a managing part, wherein the managing part comprises:
an affiliated shop managing module managing affiliated shop terminals corresponding to affiliated shops;
a customer managing module managing a mobile communication terminal information of a customer and customer information; and
a bank company managing module managing bank company information of a customer and bank company information of an affiliated shop.

17. The settlement relay system of claim 9, further comprising:
an authentication result information storing part storing authentication result information.

18. The settlement relay system of claim 9, further comprising:
a customer relationship management (“CRM”) information storing part storing an CRM information.

19. The settlement relay system of claim 9, further comprising:
an unmanned automatic sensing part performing a monitoring operation and an automatically backup operation.

20. A settlement relay method by using a relay server connected to a home shopping system, a mobile communication terminal of a customer and a credit card company system, the method comprising:
receiving a serial number of goods advertized at the home shopping system from the mobile communication terminal;
transmitting corresponding goods and customer information provided from the mobile communication terminal to the home shopping system;
transmitting purchase details information to the mobile communication terminal, when goods information and delivery address information corresponding to a customer are received from the home shopping system;
requesting a settlement to the credit card company system, when a credit card settlement through inputting a credit card number or a mobile secure socket layers (“SSL”) client certificate settlement through transmitting a mobile SSL client certificate is request by the mobile communication terminal; and
transmitting a settlement completion notification to the mobile communication terminal and the home shopping system, when a settlement response corresponding to a corresponding settlement from the credit card system is provided.

21. The settlement relay method of claim 20, wherein the mobile SSL client certificate further comprises a phone number data of the mobile communication terminal encoded therein.

22. The settlement relay method of claim 21, further comprising:
inquiring whether a corresponding mobile communication terminal is lost or not to a mobile communication company system, when goods information and delivery address information corresponding to a customer are received from the mobile communication terminal.

23. A settlement relay system, which is connected to a home shopping system, a mobile communication terminal of a customer and a credit card company system, comprising:
a communication part connected to the home shopping system and the mobile communication terminal through a communication network; and
a system control part (i) receiving a serial number of goods advertized at the home shopping system from the mobile communication terminal through the communication part, (ii) transmitting corresponding goods and customer information provided from the mobile communication terminal to the home shopping system, (iii) transmitting purchase details information to the mobile communication terminal, when goods information and delivery address information corresponding to a customer are received from the home shopping system, (iv) requesting a settlement to the credit card company system, when a credit card settlement through inputting a credit card number or a mobile SSL client certificate settlement through transmitting a mobile SSL client certificate is request by the mobile communication terminal, and (v) transmitting a settlement completion notification to the mobile communication terminal and the home shopping system, when a settlement response corresponding to a corresponding settlement from the credit card system is provided.

24. The settlement relay method of claim 23, wherein the mobile SSL client certificate further comprises a phone number data of the mobile communication terminal encoded therein.

25. A settlement relay method by using a relay server connected to an affiliated shop terminal, a mobile communication terminal of a customer and a credit card company system, the method comprising:
receiving a number capable of identifying a credit card company, an affiliated shop number and the table number from the mobile communication terminal via a communication network;
requesting a receipt serial number corresponding to the table number to the affiliated shop terminal;
receiving an affiliated shop number and the receipt serial number from the affiliated shop terminal;
transmitting an affiliated shop name corresponding to the affiliated shop number and a transaction amount to the mobile communication terminal, and requesting a credit card settlement to the mobile communication terminal;
transmitting the affiliated shop name and the receipt serial number to the credit card company system;
receiving an approval response corresponding to a settlement of the mobile communication terminal from the credit card company system; and
transmitting the approval response to the affiliated shop terminal and the mobile communication terminal.

26. The settlement relay method of claim 25, wherein the receipt serial number corresponds to a table number inputted through the mobile communication terminal in accordance with an operation of the customer.

27. The settlement relay method of claim 25, wherein the receipt serial number corresponds to a table position calculated by the mobile communication terminal in accordance with an operation of the customer.

28. A settlement relay system, which is connected to an affiliated shop terminal, a mobile communication terminal of a customer and a credit card company system, comprising:
a communication part connected to the affiliated shop terminal and the mobile communication terminal through a communication network; and
a system control part (i) receiving a number capable of identifying a credit card company, an affiliated shop number and the table number from the mobile communication terminal via the communication part, (ii) requesting a receipt serial number corresponding to the table number to the affiliated shop terminal via the communication part, (iii) receiving an affiliated shop number and the receipt serial number from the affiliated shop terminal via the communication part, (iv) transmitting an affiliated shop name corresponding to the affiliated shop number and a transaction amount via the communication part and requesting a credit card settlement to the mobile communication terminal via the communication part, (v) transmitting the affiliated shop name and the receipt serial number to the credit card company system via the communication part, (vi) receiving an approval response corresponding to a settlement of the mobile communication terminal from the credit card company system via the communication part, and (vii) transmitting the approval response to the affiliated shop terminal and the mobile communication terminal via the communication part.
